(19) United States
(12) Patent Application Publication
(10) Pub. No.: US 2024/0292030 A1
(43) Pub. Date: Aug. 29, 2024

(54) METHODS AND APPARATUSES FOR ENCODING/DECODING AN IMAGE OR A VIDEO

(71) Applicant: InterDigital CE Patent Holdings, SAS, Paris (FR)

(72) Inventors: Pierre Hellier, Thorigne-Fouillard (FR); Mustafa Shukor, Paris (FR); Bharath Bhushan Damodaran, Vannes (FR); Xu Yao, Rennes (FR)

(21) Appl. No.: 18/573,260

(22) PCT Filed: Jun. 16, 2022
(86) PCT No.: PCT/EP2022/066476

§ 371 Date: Dec. 21, 2023

(30) Foreign Application Priority Data
Jun. 21, 2021 (EP) 21305845.6
Jul. 21, 2021 (EP) 21306026.2
Aug. 30, 2021 (EP) 21306163.3
Sep. 16, 2021 (EP) 21306276.3

(51) Int. Cl. H04N 19/60; H04N 19/124; H04N 19/13; H04N 19/136; H04N 19/147; H04N 19/42; H04N 19/50

(52) U.S. Cl. CPC H04N 19/60; H04N 19/124; H04N 19/13; H04N 19/136; H04N 19/147; H04N 19/42; H04N 19/50

(57) ABSTRACT

Methods and apparatuses for encoding or decoding an image or a video based on neural network are provided. In an embodiment, an image is encoded by obtaining a first latent representation of the image in a first latent space, for instance from a Generative Adversarial Network. A second latent representation of the image in a second latent is obtained from the first latent representation and encoded. In an embodiment, the second latent space is obtained from an unfolding of the first latent space based on at least one constraint. In an embodiment, the second latent space is obtained using a neural network. The methods or apparatuses can be used for image editing and/or image or video coding.

### TECHNICAL FIELD

The present embodiments generally relate to a method and an apparatus for unfolding a first latent space onto a second latent space, and more particularly to unfolding latent space based on neural network. The present embodiments also generally relate to methods and apparatuses for encoding or decoding an image or a video based on neural network.

### BACKGROUND

Generative models such as GANs (Generative Adversarial Networks) (Generative adversarial networks: An overview. IEEE Signal Processing Magazine, 35(1), 53-65, Creswell, A.W) are machine learning techniques that learn the distribution of given objects (e.g. images) and that generate plausible new ones. Recently, GANs are of interest not only for their generative capability, but also because their latent (aka hidden) space exhibits good properties emerging from the disentangled nature of the latent space. The generation factors (attributes) seem to be more “linearly” separable or disentangled than in the original space of the objects.

Hence, many techniques are developed to project an object to the GAN latent representation and manipulate it. For instance, in the case of facial image, only one of the facial attributes like “lipstick” could be changed.

In image editing, StyleGAN is a GAN architecture which has an intermediate latent space providing interpretable and disentanglement properties. This means that to change an attribute, only the related components of the intermediate latent space have to be changed. This is thus useful in image editing tasks. Recent state of the art methods in image editing (e.g. InterFaceGAN) relies on the StyleGAN latent space due to the above property, and generally consists of two steps:
1. Represents the image of interest in the latent space of StyleGAN
2. Applies the editing on the above projected latent space.

InterFaceGAN (InterfaceGAN: Interpreting the disentangled face representation learned by gans. IEEE Transactions on Pattern Analysis and Machine Intelligence, Shen Y.Y., 2020) assumes that the attributes are linearly separated and performs edit on the direction orthogonal to the hyperplane. The quality of the edited image depends on how well the image of interest is represented in the latent space of the GAN, and such representation could lose the geometrical and semantic relationships in the perceptual image space. In other words, two geometric limitations of the latent space have been identified: (a) euclidean distances differ from image perceptual distance, and (b) disentanglement is not optimal and facial attribute separation using linear model is a limiting hypothesis. For instance, an edit on an attribute of an image may have an impact on other attributes in the original space.

Therefore, there is a need for improving the state of the art.

### SUMMARY

According to an embodiment, a method for unfolding a first latent space onto a second latent space is provided, which comprises:
obtaining a first latent space representative of attributes of at least one object from an original space,
   unfolding the first latent space onto a second latent space, based on at least one constraint.

According to an embodiment, an apparatus for unfolding a first latent space onto a second latent space, which comprises one or more processors configured for:
obtaining a first latent space representative of attributes of at least one object from an original space,
unfolding the first latent space onto a second latent space, based on at least one constraint.

According to an embodiment, the first latent space is obtained from a Generative Adversarial Network. According to another embodiment, the at least one constraint is at least one of a global constraint or a local constraint. According to another embodiment, the unfolding is a semantic unfolding or a geometrical unfolding or both.

According to another embodiment, the unfolding uses a neural network. In a variant, the unfolding is based on an invertible transformation. In a further variant, the transformation is a normalizing flow.

According to another embodiment, the at least one object is an image.

According to another embodiment, a method for encoding at least one image is provided, wherein encoding at least one image includes obtaining a first latent representation of the image, in a first latent space, obtaining a second latent representation of the image in a second latent space, encoding the second latent representation as image or video data.

According to another embodiment, a method for decoding at least one image is provided, wherein decoding at least one image from image or video data includes decoding from the image or video data a latent representation of the image, obtaining another latent representation of the image from the decoded latent representation, generating the decoded image from the other latent representation.

According to another embodiment, a method for video encoding and a method for video decoding are provided.

One or more embodiments also provide an apparatus comprising one or more processors configured for performing any one of the embodiments of the methods cited above.

One or more embodiments also provide a computer program comprising instructions which when executed by one or more processors cause the one or more processors to perform any one of the methods according to any of the embodiments described above. One or more of the present embodiments also provide a computer readable storage medium having stored thereon instructions for editing a video shot, encoding at least one image or a video or decoding at least one image or a video according to the any of the embodiments described above.

One or more embodiments also provide a bitstream comprising image or video data encoded according to any one of the embodiments of the encoding method cited above. One or more of the present embodiments also provide a computer readable storage medium having stored thereon a bitstream described above.

One or more embodiments also provide a method for transmitting a bitstream comprising image or video data encoded according to any one of the embodiments of the encoding method described herein. One or more embodiments also provide an apparatus for transmitting a bitstream comprising image or video data encoded according to any one of the embodiments of the encoding method described herein.

### BRIEF DESCRIPTION OF THE DRAWINGS

FIG. 1 illustrates a block diagram of a system within which aspects of the present embodiments may be implemented, according to an embodiment.

FIG. 2 illustrates a block diagram of a system within which aspects of the present embodiments may be implemented, according to another embodiment.

FIG. 3 illustrates a method for unfolding a latent space according to an embodiment.

FIG. 4 illustrates a method for unfolding a latent space according to another embodiment.

FIG. 5 illustrates an example of the unfolding of the latent space and disentanglement of the attributes of objects according to an embodiment.

FIG. 6 illustrates some results of the method for unfolding in case of image editing, according to an embodiment.

FIG. 7 illustrates a block diagram of an embodiment of an image/video encoder.

FIG. 8 illustrates a block diagram of an embodiment of an image/video decoder.

FIG. 9 illustrates a method for encoding and decoding at least one image according to an embodiment,

FIG. 10 illustrates a method for encoding at least one image according to another embodiment,

FIG. 11 illustrates a method for decoding at least one image according to another embodiment,

FIG. 12 shows two remote devices communicating over a communication network in accordance with an example of present principles.

FIG. 13 shows the syntax of a signal in accordance with an example of present principles.

FIG. 14 illustrates some results of the method for unfolding in case of image encoding, according to an embodiment.

FIG. 15 illustrates further results of the method for unfolding in case of image encoding, according to an embodiment.

FIG. 16 illustrates other results of the method for unfolding in case of image encoding, according to an embodiment.

FIG. 17 illustrates a method for encoding and decoding a video according to an embodiment.

FIG. 18 illustrates a method for decoding a video according to an embodiment.

FIG. 19 illustrates a method for decoding a video according to another embodiment.

FIG. 20 illustrates a method for encoding a video according to another embodiment.

FIG. 21 illustrates some results of the method for encoding a video, according to an embodiment.

FIG. 22 illustrates further results of the method for encoding a video, according to an embodiment.

FIG. 23A and FIG. 23B illustrate a method for encoding and decoding a video according to another embodiment.

FIG. 24 illustrates a method for encoding a video according to another embodiment.

FIG. 25 illustrates a method for decoding a video according to another embodiment.

FIG. 26 illustrates some results of the method for encoding a video according to another embodiment.

FIG. 27 illustrates further results of the method for encoding a video, according to another embodiment.

### DETAILED DESCRIPTION

A method for unfolding a latent space is proposed and more particularly a latent space of GANs using semantic and/or geometrical constraints. Such a method provides a new desired proxy space, wherein operations on object's attributes, such as image manipulation for instance, is made easier and more efficient.

According to an embodiment, the method unfolds (geometrically speaking) the latent space of any given GAN by imposing additional constraints on the semantics of the objects, and/or on their geometrical relationship. To do so, a continuous and invertible (bijective) transformation (i.e. Normalizing Flows) is learned from the original latent space (W⁺) to a new proxy latent space (W*). Known methods for Normalizing flow are described in “Normalizing flows: An introduction and Review of Current Methods”, I. Kobyzev, S.J.D. Prince, M.A. Brubaker, IEEE Transactions on Pattern Analysis and Machine Intelligence, 2020.

To learn the desired transformation for unfolding, at least one of the following constraints are added:
Semantic unfolding. Objects that are separable should be separated linearly. This constraint is global. For instance, pictures of people wearing glasses versus not wearing glasses, or young people versus old people. This constraint aims at clustering the new latent space. In addition, for image manipulation/editing it is desirable to preserve the identity of the person after editing the latent code, thus the identity should be the same in the local vicinity of the latent code in the new space.
Geometric unfolding. Euclidian distances between objects in this new space should match perceptual distances between objects. This constraint is local.

The properties of this new space make it more suitable for operations on objects projected onto this new space. For instance, such operations comprise manipulation on images. According to this example, image editing is made easier and more efficient.

Image/Video Editing: When editing a natural object, one can project it to its hidden representation and manipulate it (for faces, beautification/de-aging/social media editing). Editing in this new space is more efficient because of the properties that have been enforced. Such methods could be either embarked on a user smartphone, or deployed on the cloud of social networks. Since the editing is more disentangled, the user has more editing capabilities with better results.

FIG. 3 illustrates a method 300 for unfolding a latent space according to an embodiment. At 310, a first latent space representative of attributes of at least one object is obtained from an original space. According to a variant, the first latent space corresponds to a latent space of a GAN. In this variant, the first latent space is thus obtained by encoding one object, for instance a face image, using the encoding module of a GAN.

At 320, the first latent space is unfolded onto a second latent space, based on at least one constraint.

As discussed above, the constraint may be a global constraint or local constraint. The constraint may be a semantic constraint which satisfies, in the second latent space, a linear separation of the attributes of the object that has been projected onto the first latent space at 310.

In another variant, the constraint may be a geometrical constraint which satisfies a matching between an Euclidean distance determined in the second latent space between the latents and a corresponding distance in the original space.

As will be discussed further below, according to an embodiment, the unfolding at 320 is based on a neural network that learns an invertible transformation, such as a normalizing flow.

According to an aspect of the present disclosure, the method for unfolding provided herein allows to avoid retraining the GAN which would be difficult and computationally expensive in order to overcome the aforementioned limitations. The method for unfolding provided herein allows to learn a transformation to map objects in the second latent space wherein the attributes of the objects are linearly separable, disentangled, the attributes can be disentangled and separated by hyperplanes, which was not perfectly the case in previous approaches, and wherein the latent Euclidean distance mimics the perceptual distance in the original space, e.g. the image space when objects are images.

Normalizing Flows (NFs) NFs are another type of generative model that consists of diffeomorphic transformations between a simple known distribution and any arbitrarily complex distribution. Due to the constraints that should be satisfied (e.g. bijectivity, tractable inverse and jacobian determinant) the expressivity of such models is limited compared to others (e.g. GANs).

FIG. 5 illustrates an example of the unfolding of the latent space and disentanglement of the attributes of objects according to an embodiment. FIG. 5 illustrates a first latent space W⁺ of a GAN, such as a StyleGAN2 as an example, having an encoder E that projects images onto its latent space W⁺ and a generator G that generates images from a latent in the latent space W⁺. In the latent space W⁺, it can be seen that attributes (represented with circles and stars in W⁺) are more or less separated by a hyperplane (curved line in W⁺). The T and T⁻¹ are the NF model and its inverse that allows to project a latent code from W⁺ to the new latent space W*. The new latent space W* satisfies the two desired properties as illustrated with:
W*ₐ illustrating the latent space wherein the attributes are disentangled and could be separated by hyperplanes (between the positive and negative regions). C is a set of attributes classifier that is used to learn T with the loss Lₐ.
W*_{d} illustrating the latent space wherein latent Euclidean distance (straight line) mimics the perceptual distance in the image space (illustrated as dashed geodesic line in the image space), this space is learnt using the loss L_{d}.

E, G and C are fixed during the training while only T is learned. Dashed arrows means that the corresponding modules are used only during training.

It is discussed below how the latent space (W*) that satisfies the two aforementioned properties is learnt, and more particularly the transformation T that allows to map a latent code into the new latent space W*:
(a) a latent Euclidean distance that mimics the perceptual one in the image space (i.e. W_{d}space) and
(b) disentanglement and linear separation of the attributes (i.e. Wₐ* space).

In addition, according to the present principles, other properties that are useful for editing could also be satisfied (i.e. Wₐ*-ID). Note that the proposed approach only requires the bijectivity of the NF, thus the prior distribution in the latent space is not imposed as the density estimation has no interest here.

It is assumed that a pretrained StyleGAN2 generator G is available, such a generator G takes a latent code w ∈W⁺ and generates a high resolution image I (i.e. 1024×1024). A bijective transformation T is thus learnt, T: W⁺→W* that maps a latent code w ∈W⁺ to w* ∈W*. To return to W⁺, the inverse T⁻¹: W⁺→W⁺ is used. The focus will be on real images, thus it is assumed that a pretrained encoder E is available that embeds the image in W⁺ such that G(E(I))≠1.

### Latent Distance Unfolding

An objective here is to learn the mapping T that map the latent codes to W_{d} such that the latent distance in this space is similar to the perceptual one in the image space. This property is obtained by minimizing the distance between the latent distance and perceptual distance as below:

$${L}_{d} = \frac{1}{N} {\sum }_{i ∈ {S}_{1} , j ∈ {S}_{2}} {( {‖ T ( E ( {I}_{i} ) ) - T ( E ( {I}_{j} ) ) ‖}_{2}^{2} - {λ}_{s} {D}_{perceptual} ( {I}_{i} , {I}_{j} ) )}^{2} \qquad Eq ( 1 )$$

S₁ and S₂ are two disjoint sets of image samples of size N. The first term is the latent Euclidean distance squared (Dᵢₙₜₑₙₜ) and D_{perceptual}(Iᵢ, Iⱼ) is the perceptual distance between Iᵢ and I. D_{perceptual}could be any perceptual distance. As an example, the VGG16 could be used. As is used to rescale D_{perceptual} to be in the same range as Dᵢₙₜₑₙₜ. However, this scaling factor could be omitted, if the NF learns the normalization factor.

In some cases, the normalization factor may be needed, for instance in image editing, the scaling factor needs to be known. Thus, in a variant, one scaling factor may be chosen and forced the NF model to have negligible effect on scaling. An example of a scaling factor value could be λₛ=10, but other value are also possible.

### Attributes Disentanglement

An objective here is to obtain two main properties. T is trained to map the latent codes to Wₐ* where it is possible to fit a hyperplane between the positive and negative regions of each attribute (i.e. a positive example is when the attribute is present in the image and the negative when it is not). In addition, it is desired that the attributes are separated (i.e. disentangled). These properties are enforced by minimizing the classification loss of a linear attribute classifier C:W*→{0,1}^{K}, where K is the number of attributes labeled in the image dataset. Choosing a linear model is mainly to enforce the first property while reducing the loss in general leads to better attributes separation/disentanglement.

Instead of using one classification model for all the attributes, one binary classification model is used for each attribute and these models are trained jointly. For each sample w, the objective is to minimize:

$${L}_{a} = {\sum }_{i = 0}^{K} {y}_{i} log ( {C}_{i} ( T ( w ) ) + ( 1 - {y}_{i} ) log ( 1 - {C}_{i} ( T ( w ) ) ) \qquad Eq ( 2 )$$

Where Ci: W*→{0,1} is the classifier for the ith attribute, yᵢ ∈{0,1} is the label of the sample w corresponding to the ith attribute. In Eq (2), the classifier is fixed and only T is optimized, because it is desired to obtain the linear separation between attributes, thus it could be any fixed linear classifier.

In a variant that is optional, the linear classifiers are pretrained first in W⁺. The motivation is that it is needed to keep the same hyperplanes between the two spaces while “re-organizing” the new space in such a way that the objective is satisfied.

Having a space that shares some properties of W* is important for image editing as W⁺ already enjoys good properties. Furthermore, it helps to converge faster.

Combining Eq (1) and Eq (2), the total loss for W* can be written as:

$${L}_{{W}^{*}} = {L}_{a} + {λ}_{d} {L}_{d} \qquad Eq ( 3 )$$

where λ_{d} allows to have a trade-off between the two losses.

### Regularizations for Image Editing

For image editing applications, additional regularization can be introduced in Eq (3) to better condition the properties of W*.

According to a variant, the person identity should be preserved after editing the latent codes. Identity preservation is thus enforced by minimizing the loss between the features extracted from a pretrained face recognition model F before and after editing, thus for a given image sample I, the loss can be written as:

$${L}_{ID} = {‖ F ( G ( E ( I ) ) - F ( G ( {T}^{- 1} ( T ( E ( I ) ) + ε ) ) ) ‖}_{2}^{2} \qquad Eq ( 4 )$$

where ∈˜N(0,I) which is a normal distribution with zero mean and identity matrix I as covariance matrix, and which simulates the editing effect.

As the mapping function in StyleGAN2 is trained to obtain a latent space (i.e. W⁺) where the images generated from this space are of high quality and with almost no artifacts, the proposed approach benefits from this by ensuring that the new space is not very different from the original one. To this end, the magnitude of the vectors in W* should be the same as in W⁺.

The magnitude regularization for a given image sample can be as follows:

$${L}_{m a g} = {( {‖ T ( E ( I ) ) ‖}_{2} - {‖ E ( I ) ‖}_{2} )}^{2} \qquad Eq ( 5 )$$

An example of Implementation Details is discussed in the following. A pretrained StyleGAN2 (G) is used on a FFHQ dataset (Tero Karras, Samuli Laine, and Timo Aila. A style-based generator architecture for generative adversarial networks. In Proceedings of the IEEE/CVF Conference on Computer Vision and Pattern Recognition, pages 4401-4410, 2019). The images are encoded in W⁺ using the pretrained StyleGAN2 encoder (E). Parameters of the generator and the encoder remain fixed in all the experiments. The latent vector dimension in W⁺ and W* is (18,512). Celeba-HQ (Tero Karras, Timo Aila, Samuli Laine, and Jaakko Lehtinen. Progressive growing of gans for improved quality, stability, and variation. arXiv preprint arXiv:1710.10196, 2017) is the image dataset that is used and has labels for K=40 attributes.

A single layer MLP (for Multiple Layer Perceptron, also known as fully connected layers) model for each attribute (Ci) is used as linear classifier which is pretrained in W⁺. For the NF model, Real NVP (Laurent Dinh, Jascha Sohl-Dickstein, and Samy Bengio. Density estimation using real nvp. arXiv preprint arXiv:1605.08803, 2016) is used without batch normalization (which would led to normalized space and affect significantly the image editing). The NF model comprises several blocks or coupling layers, each coupling layer comprises two submodules or mapping functions: the scale function (s func) and the translation function (t func). Each mapping function is similar to a small neural network comprises, in a variant, 3 fully connected (FC) layers, with LeakyReLU as hidden activation and Tanh (for tangent hyperbolic function) as output one. VGG16 (Justin Johnson, Alexandre Alahi, and Li Fei-Fei. Perceptual losses for real-time style transfer and super-resolution. In European conference on computer vision, pages 694-711.Springer, 2016) is used as a perceptual loss and As=1. The VGG16 comprises several blocks, each one comprising several layers. Output of intermediate blocks (or features maps) of Blocks 2, 3 and 4 are taken. For the face recognition model F, a pretrained VGG16 is used on a face recognition dataset. Adam optimizer is used with 31=0.9 and 32=0.999, learning rate=1e-⁴ and the batch size=8.

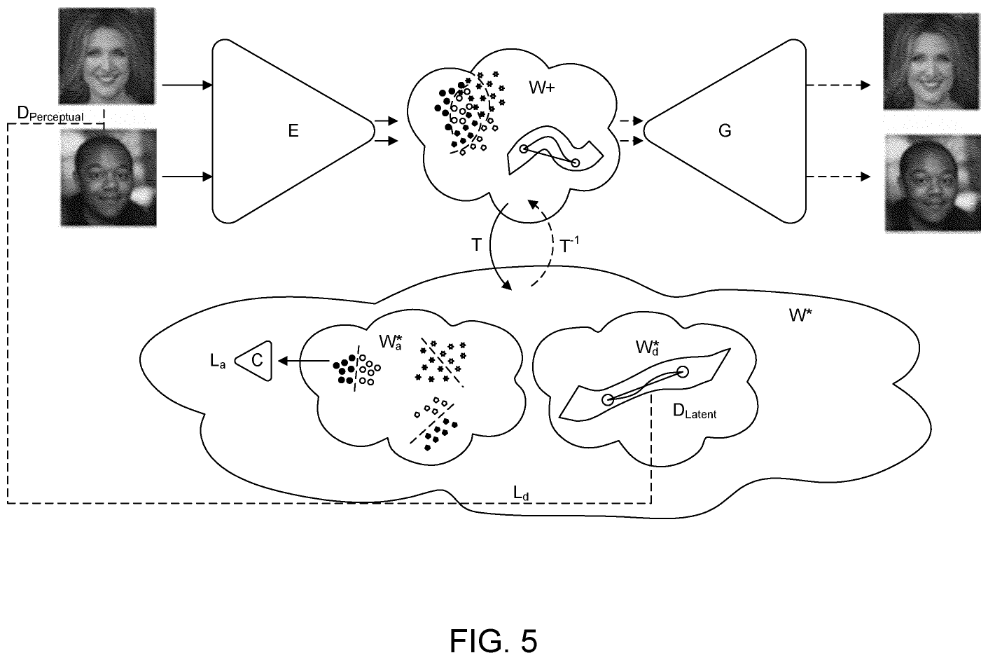

FIG. 4 illustrates a method 400 for unfolding a latent space according to another embodiment. In this embodiment, image editing is performed in the new latent space W*, wherein the transformation T has been trained as discussed above. At 410, a first representation w⁺ of an image I in a first latent space W⁺ is obtained, for instance by encoding the image I by the GAN encoder E.

At 420, a second representation w* of the image I is determined by projecting the first representation w⁺ onto the second latent space W* using the trained transform T. At 430, an edit is made on at least one attribute of the image in the second latent space W*, providing a modified second representation w*+ε. At 440, the modified second representation is remapped onto the first latent space using the inverse of the transformation T¹ and at 450, a new image is generated by the GAN generator module.

### Quantitative Metrics

Classification Accuracy: An SVM (for Support Vector Machine, which is a machine learning technique used for classification) or any other classification technique is trained from scratch for each attribute on 15000 latent codes in the corresponding space (which contains the validation set and a portion from the training one that was used for the NF training). In W⁺, these are obtained after encoding the images in Celeba-HQ using the pretrained encoder. In W*, after the encoding, the codes are mapped using the trained NF model T. The split ratio is 0.8 for the training set. 3 numbers are reported: the minimum (Min Acc) and maximum (Max Acc) accuracy among the 40 attributes as well as the Average (Avg Acc).

In DCI (for Disentanglement, Completeness and Informativeness), which is a metric introduced to quantify the disentanglement of the attributes, (C. Eastwood and C. K. Williams. A framework for the quantitative evaluation of disentangled representations. In ICLR, 2018): 40 Lasso regressors have been used, from scikit-learn library with a=0.02 that is multiplied by the L1 regularizer. The dataset size is 2000 and composed of the validation set of Celeba-HQ encoded using the pretrained encoder. The train and validation sets are split as 80% and 20% respectively. The RMSE loss is used.

### Attributes Disentanglement and Latent Distance Unfolding

In these experiments, both objectives are optimized: latent distance unfolding and attributes separation. Real NVP consists of 13 coupling layers (size=20.4 M parameter). A_{d}=1 at the beginning and is set to A_{d}=10 after 40 epochs. It is to be noted that, in the Real NVP there is no batch normalization (BN), this is important as the BN normalizes the data and the hyperplanes of the pretrained classifiers are obtained on the unormalized space W⁺. From Table 1, it can be noticed a significant improvement in all the quantitative metrics in W*.

TABLE 1
Attributes Disentanglement and latent distance unfolding results.
It can be noticed that all the metrics are better in W*.

| | Min | Max | Avg | | | | | |
|---|---|---|---|---|---|---|---|---|
| Space | Acc ↑ | Acc ↑ | Acc ↑ | D ↑ | C ↑ | I ↑ | Mean ↓ | STD ↓ |
| [symbol] ⁺ | 0.635 | 0.979 | 0.834 | 0.59 | 0.43 | 0.30 | 1.95 | 0.57 |
| [symbol] * | 0.766 | 0.991 | 0.931 | 0.82 | 0.55 | 0.26 | 0.24 | 0.15 |

### Image Editing

To assess qualitatively the new space, InterFaceGAN (Yujun Shen, Ceyuan Yang, Xiaoou Tang, and Bolei Zhou. Interfacegan: Interpreting the disentangled face representation learned by gans. IEEE Transactions on Pattern Analysis and Machine Intelligence, 2020) was retrained to manipulate the attributes of a given real image in both W⁺ and Wₐ*.

InterFaceGAN assumes that the positive and negative examples of each attribute is linearly separable and the editing direction is simply the normal to the hyperplane that separates the positive and negative regions. Specifically, to obtain these hyperplanes, an SVM is trained for each attribute in both spaces and the latent code of the image encoded by the pretrained encoder is edited. In Wₐ*, the image is first encoded and then the latent codes are mapped using (T). To generate the image using the pretrained StyleGAN2 generator after editing in Wₐ*, the latent codes are remapped using the inverse of Real NVP (T⁻¹). The total loss for attributes separation and identity regularization (i.e. Wₐ*) is as follows:

$${L}_{{W}_{a}^{*}} = {L}_{a} + {λ}_{ID} {L}_{ID} \qquad Eq ( 6 )$$

Implementation details: Real NVP consists of 3 coupling layers (size=4.7 M parameter) and is usually trained with additional objectives. According to a variant, only the loss (objective) defined in of Eq(6) is minimized. The same setup as in above is adopted. The editing directions are obtained after training an SVM on 15000 images of Celeba-HQ encoded using the pretrained encoder in W⁺ and Wₐ*. The editing step=6 for W⁺ and 10 in Wₐ*.

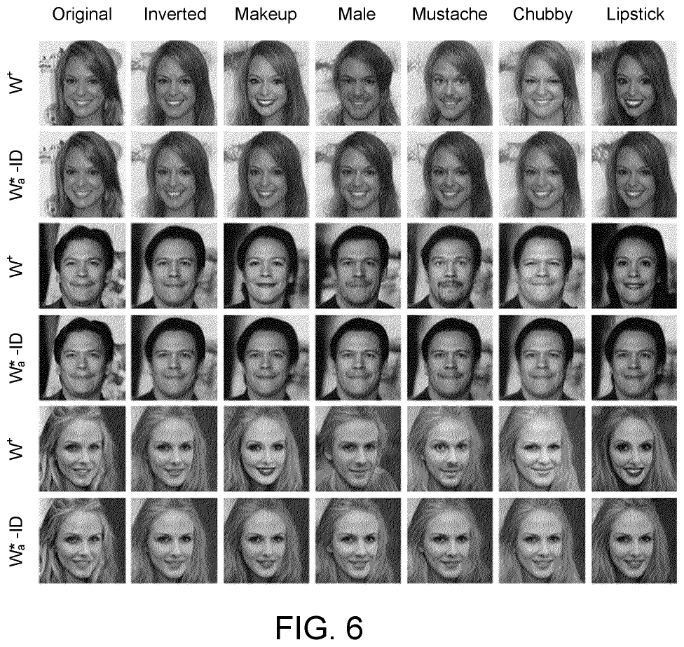

Results: FIG. 6 illustrates some results of the method for unfolding in case of image editing on 3 different images. The results from FIG. 6 are obtained for image editing using InterFaceGAN in W⁺ and Wₐ*, wherein the first column shows the original image, the second column illustrated the inverted image (mapped to the latent space W⁺—first line—or Wₐ*—second line shown as Wₐ*-ID, and back to the original space without any edit), the other columns illustrate an edit on a specific attribute identified by the name of the column with the edit being performed in the latent space W⁺(first line) or Wₐ* (second line).

It can be noticed from FIG. 6 that the editing results in Wₐ* is better than in W⁺. In particular: in W⁺, gender is still entangled with adding Makeup and Lipstick (3rd row where the male gender is changed to female). Changing the gender to Male is entangled with adding Beard and the Hair (column 4). Adding Mustache is entangled with gender (row 5).

While in Wₐ*, these attributes are better disentangled. The identity is better preserved in Wₐ*. Finally, it is clear that high quality images are still obtained even if the generator has not bee retrained.

### Ablation Study

Quantitative evaluation: In this section, the effect of some design choices is investigated. The setup is the same as above except when stated otherwise. A_{d}=10 from the beginning of the training and kept constant. 4 experiments are analyzed, which differ from the main setup with the following: H (High model capacity, 13 coupling layers),
L (Low model capacity, 4 coupling layers),
R (using random classifier, 13 coupling layers),
1R (using one random classifier with 1 linear layer for all the attributes at once. 13 coupling layers).

TABLE 2
Ablation study on Celeba-HQ dataset

| | Min | Max | Avg | | | | | |
|---|---|---|---|---|---|---|---|---|
| Space | Acc ↑ | Acc ↑ | Acc ↑ | D ↑ | C ↑ | I ↓ | Mean ↓ | STD |
| [symbol] ⁺ | 0.635 | 0.979 | 0.834 | 0.59 | 0.43 | 0.30 | 1.95 | 0.57 |
| [symbol] * (H) | 0.787 | 0.991 | 0.928 | 0.82 | 0.56 | 0.27 | 0.17 | 0.15 |
| [symbol] * (L) | 0.777 | 0.992 | 0.913 | 0.81 | 0.55 | 0.26 | 0.13 | 0.14 |
| [symbol] * (R) | 0.654 | 0.992 | 0.927 | 0.80 | 0.54 | 0.27 | 0.25 | 0.21 |
| [symbol] * (1R) | 0.686 | 0.988 | 0.873 | 0.79 | 0.55 | 0.27 | 0.0004 | 0.04 |

From Table 2:
Model Capacity (H/L): it can be noticed that higher model capacity is important for better attribute separation. Although it is not necessary for latent distance unfolding where the Mean and STD are slightly lower.
Random Classifier (R): Better initialization of the classifier leads to slightly better separation.
One Random Classifier (1R): Using one classifier for all the attributes gives worse separation, which can be explained by the capacity of the model (1 layer vs 40 layers) or the fact that optimizing for one class is easier than for 40 classes (even though all the classifiers are optimized jointly). In addition, it is noticed that the classification loss is less, compared to using 40 classifiers, which may have an equivalent effect as multiplying the unfolding loss by a higher Ad, thus the distance unfolding results are better.

Qualitative evaluation, Image Editing: In general, the magnitude and the identity preservation losses help to preserve the identity and allow high quality image editing. Although, the effect of identity loss is better and when combined with the magnitude loss the results get slightly worse. The latent distance unfolding loss does not give any benefit for editing.

Image Editing: It is noticed in some experiments that the new space should not be very different from the original one to obtain good editing results. For instance, if the latent and perceptual distances are not in the same scale, an editing step in W* could be equivalent to times 10 higher or lower in W⁺. In this regard, some constraint are added on the model such as the magnitude regularization (to ensure that the new space is not contracted/expanded) and the same boundaries (editing directions) are kept in W*. Although, using the identity regularization is enough to replace these two constraints. When using the latter, it is important to choose carefully its weight. For example, if the weight is high and the model is trained for too long the editing effect will be smaller.

Beyond StyleGAN: Some effort was devoted to do image editing and to improve the attributes disentanglement for other generative models such as GANS and VAEs. The proposed attribute separation approach could be extended in a straightforward way to such type of models. For distance unfolding, the scope of models is larger as any model with a latent space could be adopted. Other properties could be enforced as well. For instance, for image editing, a head pose preservation loss could be adopted.

Retraining the whole model: Enforcing these properties is also possible by optimizing directly the latent space while training the generator/discriminator as it is done in many recent work on attributes disentanglement. According to another embodiment, the method for unfolding a latent space described in reference with FIG. 3 is used for encoding/decoding at least one image. According to this embodiment, the unfolding is based on a rate/distortion constraint.

Several embodiments are provided below which provide a new compression scheme using inverted GAN. In the image/video compression scheme provided below, a GAN encoder, for instance a StyleGAN encoder, is used for mapping each video frame to a latent point in the GAN latent space, for instance with dimension 18×512.

According to an embodiment, an intra coding scheme or image compression method that provides an entropy model learned in the proxy latent space is provided. According to another embodiment, an inter-coding scheme for video compression is provided wherein intermediate frames latent codes are linearly interpolated in the proxy latent space from intra coded latent codes.

According to another embodiment, an inter-coding scheme for video compression is provided wherein entropy model for successive differences between latent codes is learned.

At low bitrates, traditional image codecs favor blocking artifacts, while other deep compression systems are unable to reconstruct a sharp, unblurred and high quality images. To remedy this, it is proposed to leverage the generative power of Generative adversarial networks (GANs) for image compression. To alleviate the burden of adversarial training, a proxy latent space dedicated for compression is learnt while the pretrained and off the shelf GAN encoder and decoder are freezed.

In other words, it is learnt how to efficiently compress the latent code associated to a given image, for example a face image, but the method is not limited to this kind of images.

In addition, a new perceptual distortion loss is proposed that is more efficient to compute than other counter parts (such as LPIPS defined in Richard Zhang, Phillip Isola, Alexei A Efros, Eli Shechtman, and Oliver Wang. The unreasonable effectiveness of deep features as a perceptual metric. In Proceedings of the IEEE conference on computer vision and pattern recognition, pages 586-595, 2018, or VGG16). The method proposed herein (SGANC) is simple, faster to train and shows better qualitative results compared to state of the art codecs such VVC, AV1 and recent deep learning-based ones for low bitrates.

Image compression can be formulated as an optimization problem with the objective of finding a codec with minimal bitrate for a given distortion level between the reconstructed image at the decoder side and the original one. The distortion is mainly due to the image quantization, as compression codecs work with discrete data. On the other hand, as bitrate is lower bounded by the entropy, the mismatch between the predicted data distribution and the real one leads to higher bitrate. Thus, good codecs are the ones with good probability models of the underlying data. Due to the fact that images live in high dimension space, the optimization in this space is intractable, thus, usually they are transformed first to a latent code with lower dimension before quantization/compression. This scheme is classically called transform coding.

Traditional image codecs (e.g., JPEG, JPEG2000) are based on handcrafted and linear transformations, unlike the recent deep learning-based codecs or deep compression systems (Johannes Balle, Valero Laparra, and Eero P Simoncelli. End-to-end optimized image compression. arXiv preprint arXiv:1611.01704,2016a. [Ballé et al., 2016a]) which learn nonlinear transformations that are more adapted to the processed data. These recent models optimize jointly a rate-distortion loss:

$$L = - 𝔼 [ {log}_{2} {P}_{z} ] + λ 𝔼 [ d ( x , \hat{x} ) ] \qquad Eq ( 7 )$$

where x, z are the original and the reconstructed images, z is the corresponding latent code, P_{z}(_) is the data distribution and d(x, z) is any distortion loss.

Usually, the distortion loss is chosen to be one of the traditional metrics that are used to assess compression systems such as PSNR or MS-SSIM. Although, these metrics capture the pixel wise distortion and focus on the texture rather than the perceptual distortion or the global appearance. Moreover, it has been shown that there is a tradeoff between pixel wise distortion and perceptual quality. This observation is seen clearly for very low bitrate or bit per pixel (bpp), where traditional codecs favor blocking artifacts and deep compression systems show blurred and other types of artifacts.

According to the embodiment described herein, the encoding/decoding method leverages the generative power of StyleGAN and the GANs inversion techniques such as in Elad Richardson, Yuval Alaluf, Or Patashnik, Yotam Nitzan, Yaniv Azar, Stav Shapiro, and Daniel Cohen-Or. Encoding in style: a stylegan encoder for image-to-image translation. arXiv preprint arXiv:2008.00951, 2020, or in Tianyi Wei, Dongdong Chen, Wenbo Zhou, Jing Liao, Weiming Zhang, Lu Yuan, Gang Hua, and Nenghai Yu. A simple baseline for stylegan inversion. arXiv preprint arXiv:2104.07661, 2021, for high quality, lower perceptual distortion and efficient training image compression.

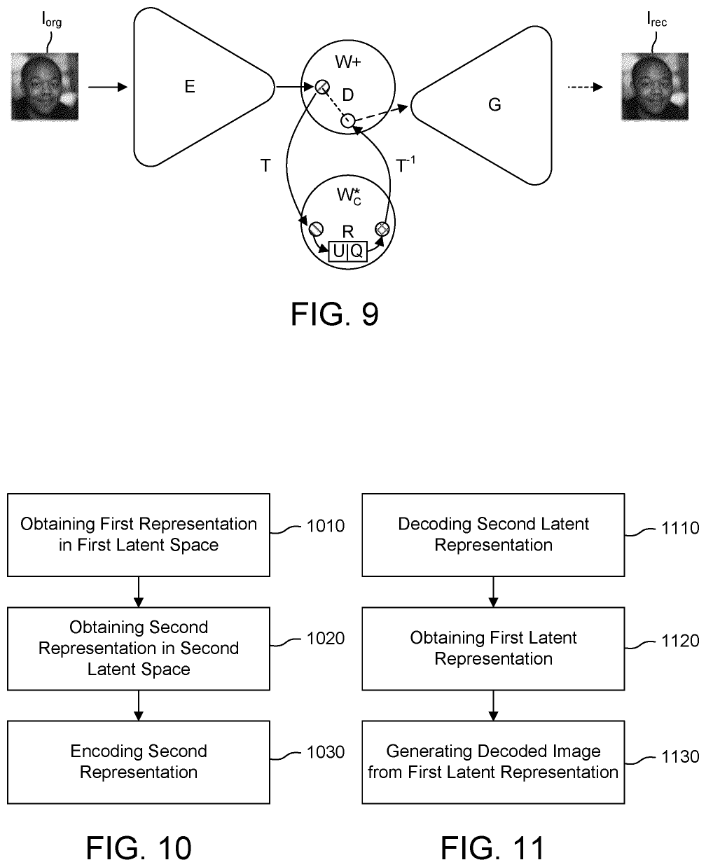

According to an embodiment illustrated on FIG. 9, an image I_{org} is projected in a latent space using a StyleGAN encoder, then the latent code is mapped to a proxy latent space using a bijective transformation T (for instance Normalizing flows NF), where it is quantized/compressed. On the decoder side, the compressed latent code is decompressed and mapped back using the inverse of T to the original latent space before feeding it to StyleGAN generator to reconstruct the image. On FIGS. 9, E and G are the StyleGAN2 encoder and generator respectively, which are not retrained. According to this embodiment, two networks are used: one network for the NF mapping T and one network for the entropy model (UJQ). Only the NF mapping T and the entropy model (UJQ) are trained jointly using the joint rate (R) and distortion (D) loss.

On the encoding side, the images are projected in the latent space (W⁺). The latent obtained from the projection is then mapped to the proxy latent space W*_{c} where the quantization/compression is done, providing coded image data. In an embodiment, the coded image data can then be transmitted in a bitstream to a decoder. On the decoding side, the coded image data are obtained from the bitstream and decompressed/decoded. The decoded image data is then mapped from the proxy latent space W*_{c} back to the latent space W⁺, before generating the reconstructed image I_{rec} using the GAN generator.

According to the embodiments for encoding/decoding images described herein, the burden of retraining the StyleGAN encoder/decoder is avoided as a proxy latent space dedicated for compression is learned while using off the shelf pretrained StyleGAN encoder/decoder models.

The proposed scheme shows high quality and lower perceptually distorted reconstructed images for low bitrates, better quantitative metrics for medium and high bitrates in terms of MS-SSIM and LPIPS and better PSNR metrics for high bitrates.

According to a variant of the embodiment illustrated on FIG. 9, when considering a facial image/video, the main idea is to retrieve the latent code of a pretrained GAN so that the image can be well approximated by the model using the encoder E. Once the face image is associated with a latent code, the encoding method proposed here optimizes the transmission of the image.

In particular, the method relies on computing a normalizing flow T bijective transformation so that an optimal coding scheme can be learned in this new latent space (W*c). In the following, are described the Gan approximation, as well as the training of the optimal intra compression method.

The Generator StyleGAN is a state of the art unconditional GAN in high quality image generation. It consists of a mapping function that takes a noise vector and maps it to an intermediate latent space (i.e., W) before feeding it to multiple stages of the generator to generate the image. It is shown that the latent space of StyleGAN is semantically rich and the generative factors are better disentangled thus making it better for interpolation. According to an embodiment, a StyleGAN2 encoder/generator (Tero Karras, Samuli Laine, Miika Aittala, Janne Hellsten, Jaakko Lehtinen, and Timo Aila. Analyzing and improving the image quality of stylegan. In Proceedings of the IEEE/CVF Conference on Computer Vision and Pattern Recognition, pages 8110-8119, 2020.) is used, which is an improved version of StyleGAN discussed above. However, the method for encoding an image proposed herein is not limited to the StyleGAN2 networks, and any GAN model can be used.

The StyleGAN encoder's role is to project an image in the latent space of StyleGAN (e.g., W, W⁺) in such a way that the image reconstructed by the generator is minimally distorted. According to this embodiment, the image is projected in W⁺ with dimension (18×512).

Normalizing Flows (NFs) are another type of generative models that consists of diffeomorphic transformations between a simple known distribution and any arbitrarily complex one. In this embodiment, a same parametrization as the one used in the embodiments described in reference with FIG. 3-5 is used.

Regarding the Intra Compression, an objective is to minimize the rate-distortion loss. In addition, to avoid the burden of retraining the StyleGAN encoder/generator, a proxy space W*_{c} is introduced.

As in the embodiments described in reference with FIG. 3-5, this proxy space W*_{c} is obtained from an unfolding of the latent space W⁺ onto which the image has been projected.

It is assumed a pretrained StyleGAN2 generator G that considers a latent code w ∈W⁺ and generates a high resolution image I (for instance 1024×1024).

A bijective transformation T: W⁺→W*_{c} is trained to map a latent code w ∈W⁺ to w*, E W*_{c}. T is a Normalizing Flows (NFs) model and can be inverted explicitly. The focus will be on real images, thus it is assumed that a pretrained encoder E is available that embeds the image in W⁺ such that G(E(I))≠I.

Although, the transformation T is modelled as a NF, it is noted that the proposed method only requires the bijectivity, as such, no maximum likelihood is included in the training objective.

The entropy model is based on a fully factorized probability distribution as in [Ballé et al., 2016a].

The entropy model takes as input the latent code provided by the transformation T and outputs a probability value pₗ.

To obtain the coded image data, the latent code is quantized by applying a rounding operation and compressed using Range Asymmetric Numeral System (rANS) bindings as proposed in Duda, Jarek. “Asymmetric numeral systems: entropy coding combining speed of Huffman coding with compression rate of arithmetic coding.” arXiv preprint arXiv:1311.2540 (2013), which is a coder based on entropy coding. The entropy model takes a latent vector in W*_{c} of dimension (18×512) and it is trained jointly with the transformation T.

To train the entropy model, a method similar to the one used in [Ballé et al., 2016a] is used and the hard quantization is replaced by adding uniform noise to the latent vectors.

As the compression is done in W*_{c}, the rate loss is minimized after mapping the latent codes from W⁺ using T. The rate loss is as follows:

$$ℛ = - {𝔼}_{x , ε} [ {\sum }_{i}^{D m} {log}_{2} {p}_{i} ( T ( E ( x ) ) + ε ] \qquad Eq ( 8 )$$

where pᵢ is the ith dimension of the probability density function in W*_{c}, Dm is the latent vector dimension, x is the input image and E is sampled from a uniform distribution U_{[-0.5,0.5]}. The distortion loss is applied in the original latent space W⁺ and can be written as follows:

$$D = d ( E ( x ) , {T}^{- 1} ( T ( E ( x ) ) + ε ) \qquad Eq ( 9 )$$

Where d is any distortion measure between the latent code from W⁺ and the reconstructed latent code in W⁺ after mapping T, encoding and inverse mapping T¹.

The total loss is a trade-off between rate and distortion:

$$L = ℛ + λ D \qquad Eq ( 10 )$$

Where λ is the trade-off parameter.

In the above variant, the distortion loss is determined in the latent space W⁺ which allows for faster training. Moreover, computing the distortion in the latent space is equivalent to computation of the distortion in the image space in terms of mean squared error.

In some variant, the distortion loss can be determined in the image space (between original picture and reconstructed picture) using any distortion metrics, either pixel-based or a perceptual metric or a combination of both.

FIG. 10 illustrates a method for encoding at least one image according to an embodiment. At 1010, a first latent representation of the image in a first latent space is obtained. For instance, this can be obtained by projecting the image in W⁺ using a GAN as described above. At 1020, a second latent representation of the image in a second latent space is obtained. The second representation of the image is obtained by projection the first latent representation in the proxy space W*_{c} using the transformation T as described above. At 1030, the second latent representation is encoded as image data, for instance in a bitstream. In a variant, encoding of the second latent representation comprises entropy coding. In another variant, encoding of the second latent representation also comprises quantization.

As described above, the encoding of the second latent representation is performed using an entropy network model that has been trained jointly with the transformation T for mapping the first latent representation in the proxy space.

FIG. 11 illustrates a method for decoding at least one image according to an embodiment. At 1110, a latent representation of the image is decoded from coded image data, for instance the coded image data are obtained from a bitstream. Depending on variants, the bitstream can be received from a transmission network or coded image data are retrieved from memory storage.

In a variant, decoding of the latent representation comprises entropy decoding. In another variant, decoding of the latent representation also comprises dequantization.

As described above, the decoding of the latent representation is performed using an entropy network model that has been trained jointly with the transformation T/T⁻¹ used for mapping the first latent representation to encode in the proxy space wherein it is encoded. The latent representation is thus decoded in the proxy space.

At 1120, another latent representation of the image is obtained from the decoded latent representation. In a variant, the decoded latent representation is mapped using the transformation T⁻¹ from the proxy space to the target latent space. The target latent space corresponds here to the original latent space onto which the image has been projected on the encoder side. The target latent space is the GAN latent space. At 1130, a decoded image is generated from the latent representation that has been mapped on the target latent space, using the GAN generator.

In the following, some qualitative and quantitative results of the proposed method compared to other ones are presented.

Implementation details: a StyleGAN2 generator (G) is used, it has been pretrained on FFHQ dataset. The images are encoded in W⁺ using a pretrained StyleGAN2 encoder (E) (the parameters of the generator and the encoder remain fixed in all the experiments). The latent vector dimension in W⁺ and W*_{c} is 18×512. Celeba-HQ is the image dataset that is used for training and consists of 30000 high quality images (i.e. 1024×1024) of faces.

For the NF model, Real NVP is used without batch normalization. Each coupling layer consists of 3 fully connected (FC) layers for the translation function and 3 FC for the scale one with LeakyReLU as hidden activation and Tanh as output one. A fully factorized entropy model is trained as in [Ballé et al., 2016a]. For all the experiments, Adam optimizer is used with _β1=0,9 and β2=0,999, learning rate=1e⁻⁴ and the batch size=8.

Datasets: the method is evaluated on different datasets: FILMPAC: This dataset consists of video clips with high resolution and length between 60 and 260 frames.

MEAD intra: MEAD dataset, defined in Kaisiyuan Wang, Qianyi Wu, Linsen Song, Zhuoqian Yang, Wayne Wu, Chen Qian, Ran He, Yu Qiao, and Chen Change Loy. Mead: A large-scale audio-visual dataset for emotional talking-face generation. In ECCV, 2020, is a high resolution talking face video corpus for many actors with different emotions and poses. MEAD intra consists of 200 frames selected from these videos with frontal pose. It contains frames from around 40 actors, with different expressions (i.e., neutral, happy, sad).

Dataset preprocessing: All the frames are cropped around the face and aligned. As the reconstructed image is compared with the projected one for SGANC, instead of feeding the original image, other methods are fed with the projected image. All frames are with resolutions (1024×1024).

### Results:

In these experiments, each frame is quantize/compress independently of the videos (Intra coding) and the average of the metrics is reported over all the frames of a given video.

The method is compared with respect to Versatile Video Coding Test Model (VTM), AV1, factorized model with scale and mean hyperpriors (MeanHP) described in David Minnen, Johannes Balle, and George Toderici. Joint autoregressive and hierarchical priors for learned image compression. arXiv preprint arXiv:1809.02736, 2018.

The following metrics are used: Peak Signal to Noise Ratio (PSNR), Multi Scale Structural Similarity (MS-SSIM) defined in H. Zhao, O. Gallo, I. Frosio, and J. Kautz. Loss functions for image restoration with neural networks. IEEE Transactions on Computational Imaging, 3(1):47-57, 2017. doi:10.1109/TCI.2016.2644865, and Learned Perceptual Image Patch Similarity (LPIPS). The size of the compressed images in bits per pixel (BPP) is reported.

Note that, all the distortion metrics of the method (SGANC) are reported w.r.t the projected image while all the others are w.r.t to the original one.

Qualitative results: As can be seen in FIG. 14, for low BPP, traditional methods introduce block artifacts (AV1) and the images are blurred (VTM) especially at the face and hair edges. MeanHP also lack sharpness and the colors of the images are not preserved. Compared to the projected image, the proposed encoding method (SGANC) has competing pixel-wise performance.

Even though, the proposed encoding scheme uses off the shelf Encoder/Generator that are trained on different datasets (FFHQ for StyleGAN, Celeba-HQ for the compression training and the evaluation is done on a third dataset), it is still possible to get artifacts-free images that are perceptually close to the original image.

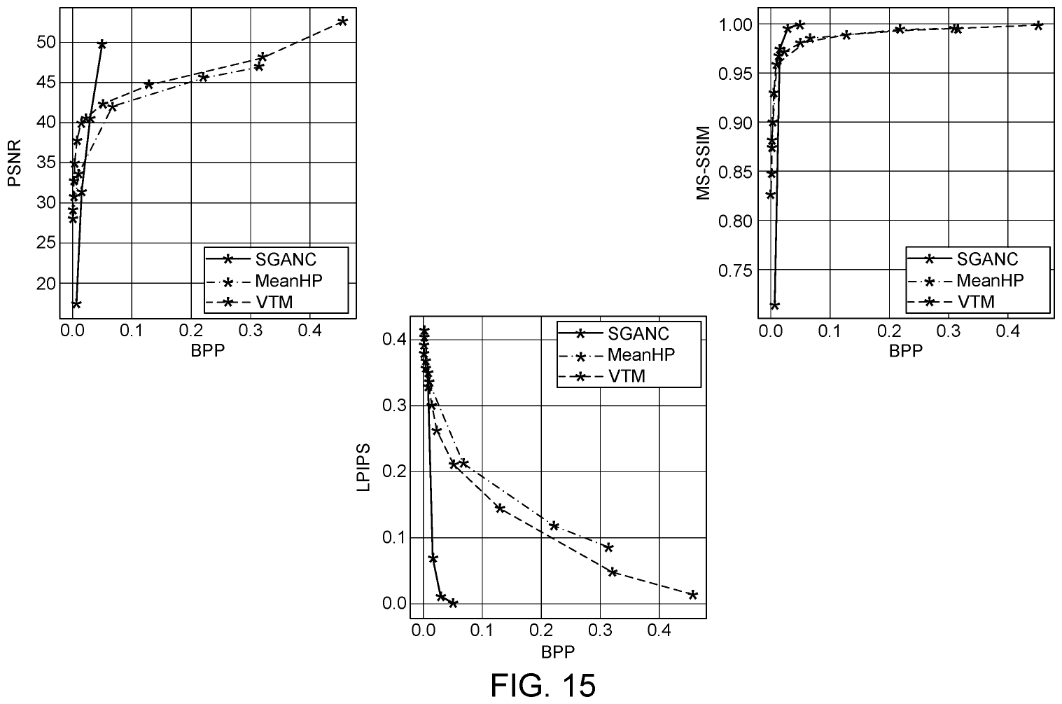

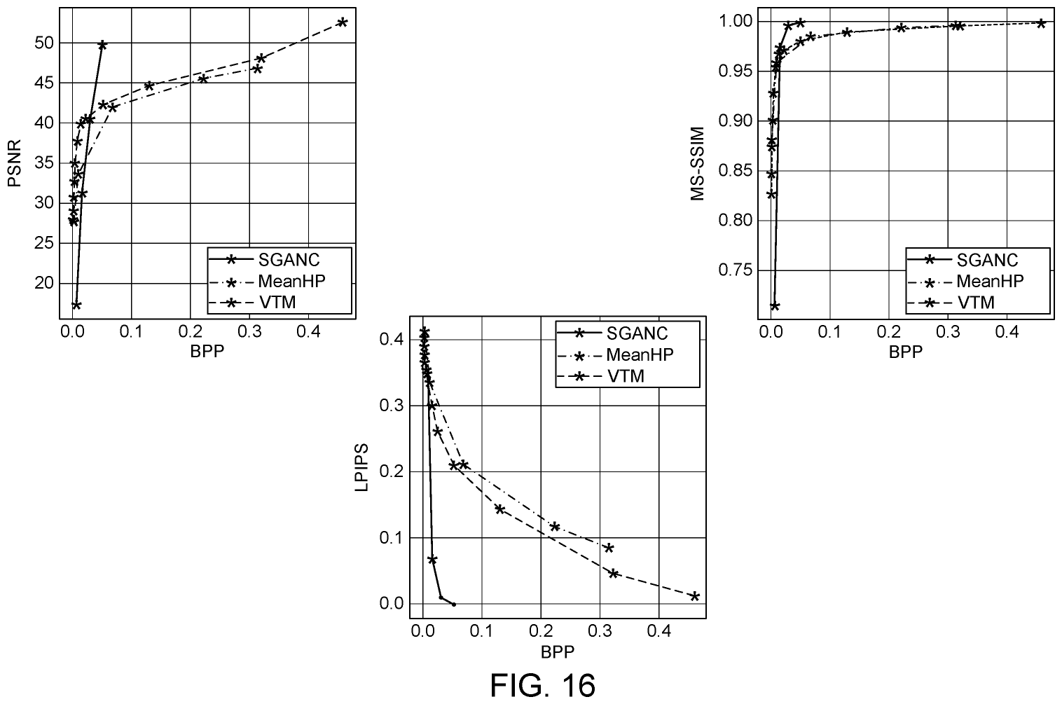

Quantitative results: FIG. 15 illustrates rate-distortion curves for the MEAD intra dataset for the SGANC method, VTM and Mean HP encoder, using different distortions. FIG. 16 illustrates rate-distortion curves for the filmpac FP006734MD02 video for the SGANC method, VTM and Mean HP encoder, using different distortions.

As can be seen in FIGS. 15 and 16, the proposed method (SGANC) outperforms other methods w.r.t the LPIPS perceptual distance. For low, medium and high BPP the proposed method is better in terms of MS-SSIM perceptual metric and for PSNR, the proposed method is better for high BPP. Note that, for the proposed method, the projected image is used for comparison.

In the methods for encoding/decoding at least one image described above, results are provided for face images, however, the present principles are not limited to this kind of images and the methods provided herein applies to any other kind of images, as long as a network model is available for projecting the image into the first latent space from which a similar image can generated, such as with a GAN network.

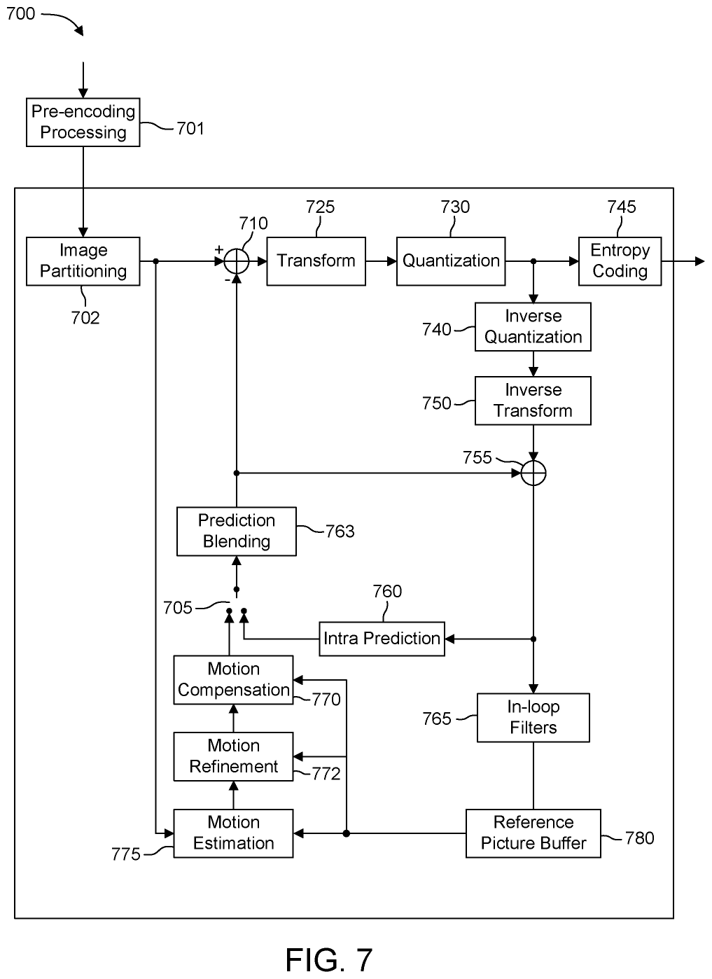

FIG. 7 illustrates an example video encoder 700, such as a High Efficiency Video Coding (HEVC) encoder. FIG. 7 may also illustrate an encoder in which improvements are made to the HEVC standard or an encoder employing technologies similar to HEVC, such as a VVC (Versatile Video Coding) encoder developed by JVET (Joint Video Exploration Team).

In the present application, the terms “reconstructed” and “decoded” may be used interchangeably, the terms “encoded” or “coded” may be used interchangeably, the terms “pixel” or “sample” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (701), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 700, a picture is encoded by the encoder elements as described below. The picture to be encoded is partitioned (702) and processed in units of, for example, CUs. Each unit is encoded using, for example, either an intra or inter mode. When a unit is encoded in an intra mode, it performs intra prediction (760). In an inter mode, motion estimation (775) and compensation (770) are performed. The encoder decides (705) which one of the intra mode or inter mode to use for encoding the unit, and indicates the intra/inter decision by, for example, a prediction mode flag. The encoder may also blend (763) intra prediction result and inter prediction result, or blend results from different intra/inter prediction methods.

Prediction residuals are calculated, for example, by subtracting (710) the predicted block from the original image block. The motion refinement module (772) uses already available reference picture in order to refine the motion field of a block without reference to the original block. A motion field for a region can be considered as a collection of motion vectors for all pixels with the region. If the motion vectors are sub-block-based, the motion field can also be represented as the collection of all sub-block motion vectors in the region (all pixels within a sub-block has the same motion vector, and the motion vectors may vary from sub-block to sub-block). If a single motion vector is used for the region, the motion field for the region can also be represented by the single motion vector (same motion vectors for all pixels in the region).

The prediction residuals are then transformed (725) and quantized (730). The quantized transform coefficients, as well as motion vectors and other syntax elements, are entropy coded (745) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (740) and inverse transformed (750) to decode prediction residuals. Combining (755) the decoded prediction residuals and the predicted block, an image block is reconstructed. In-loop filters (765) are applied to the reconstructed picture to perform, for example, deblocking/SAO (Sample Adaptive Offset) filtering to reduce encoding artifacts. The filtered image is stored at a reference picture buffer (780).

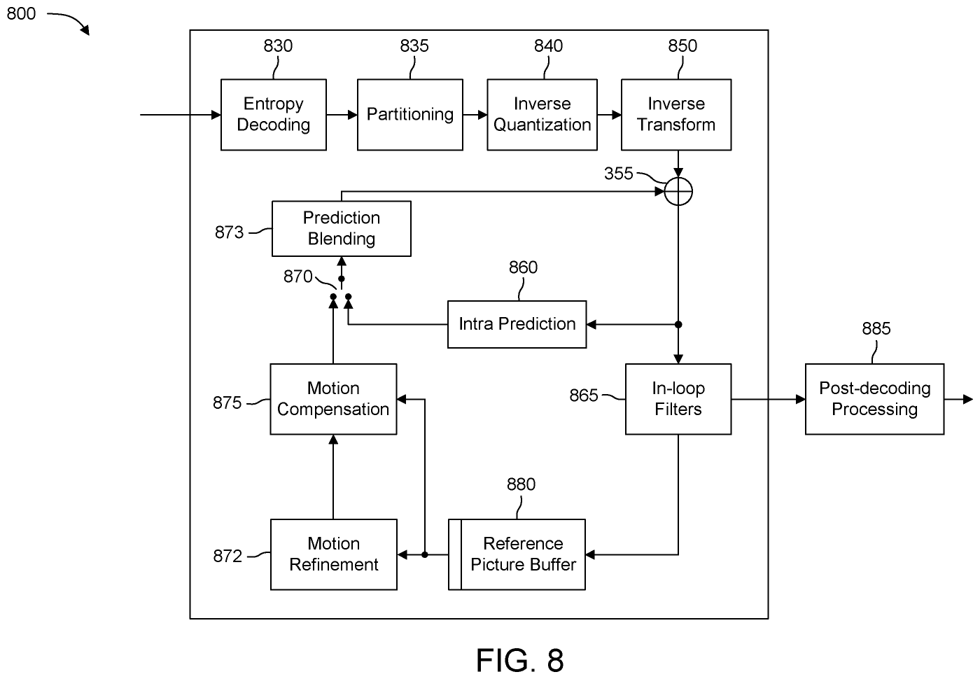

FIG. 8 illustrates a block diagram of an example video decoder 800. In the decoder 800, a bitstream is decoded by the decoder elements as described below. Video decoder 800 generally performs a decoding pass reciprocal to the encoding pass as described in FIG. 7. The encoder 700 also generally performs video decoding as part of encoding video data.

In particular, the input of the decoder includes a video bitstream, which can be generated by video encoder 700. The bitstream is first entropy decoded (830) to obtain transform coefficients, motion vectors, and other coded information. The picture partition information indicates how the picture is partitioned. The decoder may therefore divide (835) the picture according to the decoded picture partitioning information. The transform coefficients are de-quantized (840) and inverse transformed (850) to decode the prediction residuals. Combining (855) the decoded prediction residuals and the predicted block, an image block is reconstructed.

The predicted block can be obtained (870) from intra prediction (860) or motion-compensated prediction (i.e., inter prediction) (875). The decoder may blend (873) the intra prediction result and inter prediction result, or blend results from multiple intra/inter prediction methods. Before motion compensation, the motion field may be refined (872) by using already available reference pictures. In-loop filters (865) are applied to the reconstructed image. The filtered image is stored at a reference picture buffer (880).

The decoded picture can further go through post-decoding processing (885), for example, an inverse color transform (e.g. conversion from YCbCr 4:2:0 to RGB 4:4:4) or an inverse remapping performing the inverse of the remapping process performed in the pre-encoding processing (801).

The post-decoding processing can use metadata derived in the pre-encoding processing and signaled in the bitstream.

According to an embodiment, when an image is to be intra-coded using the encoder and decoder described above in reference to FIG. 7 and FIG. 8, the encoding method and the decoding method described in relation with FIG. 9-11 can be used for encoding/decoding the intra picture.

According to another embodiment, the method for unfolding a latent space described in reference with FIG. 3 is used for encoding/decoding a video. According to this embodiment, as in the case of the intra coding, the unfolding is based on a rate/distortion constraint.

Video compression methods tries to reduce as much as possible the temporal (TR) and spatial (SR) redundancy.

Some works proposed to reduce the TR in the feature or latent space; such as computing the feature space residual as in Abdelaziz Djelouah, Joaquim Campos, Simone Schaub-Meyer, and Christopher Schroers. Neural inter-frame compression for video coding. In 2019 IEEE/CVF International Conference on Computer Vision (ICCV), pages 6420-6428, 2019. In this method, TR is exploited by interpolating the intermediate frames given two reference ones. The approach is based on motion estimation which makes it complex to train and requires to compress additional information (flow maps).

In Shibani Santurkar, David Budden, and Nir Shavit. Generative compression. In 2018 Picture Coding Symposium (PCS), pages 258-262, 2018, it is proposed to interpolate intermediate frames in the latent space, however, no entropy coding is used and small image resolution (64×64) is used, as well as a constant interpolation gap without any strategy to adapt it according to the type or the dynamics of the video.

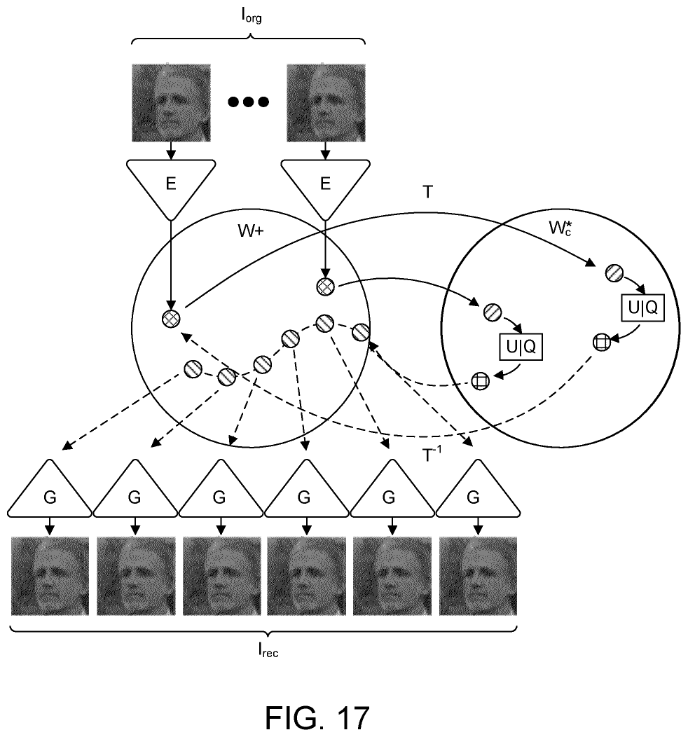

The present embodiment allows remedying these drawbacks, by leveraging the properties of the StyleGAN latent space for efficient and high quality video compression. In this embodiment, the video is divided into temporal segments of adapted lengths, the first and last frame of each segment are compressed and sent to a receiver. On the receiver side, the intermediate frames are obtained by an interpolation in the latent space, e.g. a linear interpolation is used. An example of the embodiment is illustrated in FIG. 17

In this embodiment, the properties of the latent space of StyleGAN are leveraged for simple, efficient and high quality video compression. High quality reconstructed images with lower perceptual distortion for low bitrates is achieved. Some better quantitative metrics for high bitrates in terms of MS-SSIM and LPIPS are also obtained.

FIG. 17 illustrates an example of a method for encoding and decoding a video according to an embodiment. A set of original images l_{org} of the video is fragmented into temporal segments of size GAP. In the example shown in FIG. 17, GAP=5, but any other value can be used.

For each temporal segment, the first and last images are encoded as in the intra coding scheme explained above. E and G are the StyleGAN2 encoder and generator respectively. The image is projected in the latent space of the GAN (W⁺) and mapped to the proxy latent space W*_{c} using the transformation T, where the quantization/compression is done to produce coded video data, for instance in a bitstream. According to this embodiment, only the latent codes of the first and last frames of the temporal segment are encoded in the coded video data. The first and last frames are encoded using the encoding method illustrated on FIG. 10.

On the decoder side, the coded video data are obtained, for instance from a received bitstream or retrieved from memory. The coded video data is decompressed and the decoded latent are mapped (using T⁻¹) from the proxy latent space W*_{c} to the GAN latent space W⁺, wherein the first and last frame of the temporal segment are reconstructed by the generator G. The first and last frame are decoded using the decoding method illustrated on FIG. 11.

To obtain the intermediate frames located between the first and last frames, a linear interpolation in the latent space W⁺ is performed using the latent code of the first and last frames. Then, an intermediate frame is generated by the generator using the interpolated latent code as input. In this way, a set of reconstructed frames Iᵣₑc is thus obtained for the temporal segment.

According to this embodiment, there is no need for a specific training for video compression as the same models (T and the entropy model) trained for intra coding are used. E and G are pretrained StyleGAN2 encoder and decoder respectively, and remain fixed in all of the trainings.

The latent space or the manifold of GANs is semantically rich and enables several applications such Image editing. Moreover, image interpolation on this manifold produces high quality and pleasant images. This property is leveraged to reduce temporal redundancy of frames sequence and a method for video compression is provided wherein intra coding is combined with linear interpolation in the latent space to reduce also spatial redundancy.

In this embodiment for video compression, the intra coding part is the same as the one described above, the training of the transformation T is performed in the same way for using the same rate-distortion losses (equation 8, 9 and 10).

For the inter-coding part of the scheme, the video is divided into different non overlapping segments of a size=GAP. The first and last frames (i.e., I₁, I₂ respectively) are encoded as illustrated with FIG. 10 using the pretrained encoder, quantized and compressed before sending them to the receiver. On the receiver side, these two latent codes are decompressed, sent to the original latent space (W⁺) using T¹, and decoded using the StyleGAN2 generator G to reconstruct the corresponding images, as illustrated with FIG. 11. The intermediate frames lᵢ are obtained by doing linear interpolation between the two received latent codes with a step=1/GAP:

$${I}_{i} = G ( \frac{i}{GAP} {w}_{2} + ( 1 - \frac{i}{G A P} ) {w}_{1} ) \qquad Eq ( 11 )$$

Where wi=T-1(Q (T(E(I₁)))), w₂=T-1(Q (T(E(I₂)))) are the two received latent codes in W+ and i ∈{1, . . . , GAP−1}, here Q denotes the quantization, compression coding and decoding.

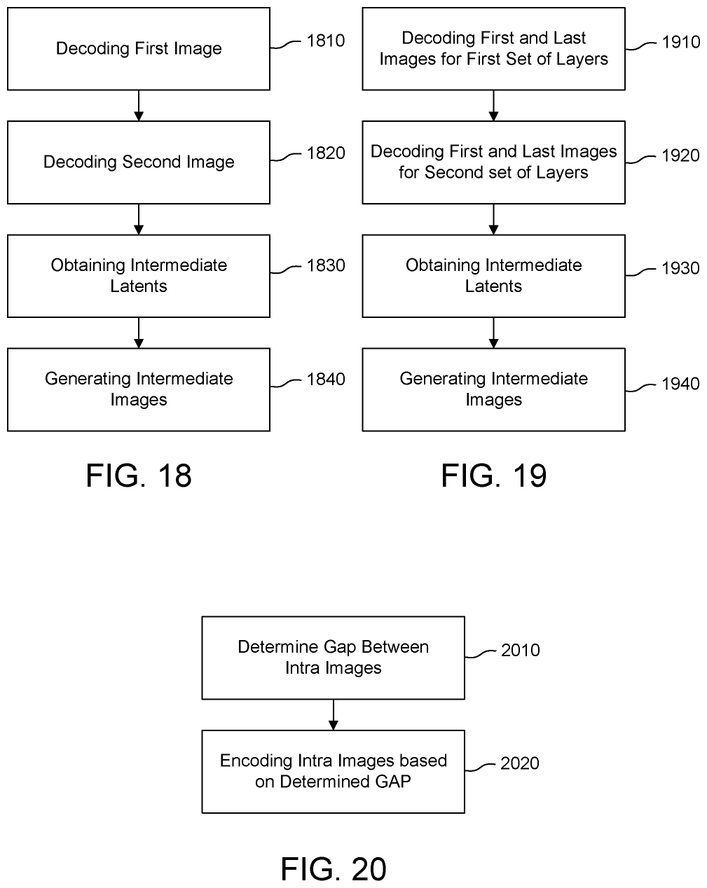

FIG. 18 illustrates a method for decoding a video according to an embodiment. Here, the method is described in the case of one temporal segment, but the method is repeated for each temporal segment of the video to decode. At 1810, a first image of the temporal segment is decoded using the decoding method illustrated in FIG. 11. A1820, a last image of the temporal segment is decoded using the decoding method illustrated in FIG. 11. A1830, intermediate latents are obtained by interpolation as explained above and at 1840, intermediate frames are generated using the GAN generator.

### GAP Adaptation

The size of the temporal segment GAP is a parameter of the method to tune. The value of the GAP could depend on the motion or the dynamics of the video as well as what type of objects are changing. In the followings, several variants are provided to adapt the GAP temporally and layer wise.

Layer specific adaptive gap (LA-GAP)

In Tero Karras, Samuli Laine, and Timo Aila. A style-based generator architecture for generative adversarial networks. In Proceedings of the IEEE/CVF Conference on Computer Vision and Pattern Recognition, pages 4401-4410, 2019 it is shown that each stage of the StyleGAN generator corresponds to specific scale of details. Specifically, the first layers, which correspond to coarse resolution (e.g., 4²-8²) affect mainly high level aspects of the image such as the pose and face shape, while the last layers affect the low level aspects such as textures, colors and small micro structures. This property is used to adapt the GAP layer wise. Specifically, small GAP value (GAP_{I}) for the first layers (e.g., 1-7) and larger one (GAPₕ) for the last layers (e.g., 7-18) are used.

This is motivated by noticing that what usually change in the videos correspond to the high level aspects while the textures, colors change slowly and their change may not be noticeable nor important. It is to be noted that as an example, in this variant, the latent code dimension is (18, 512) but other dimensions could be envisaged. The intermediate frames can be obtained by the following equations wherein the latent code of an intermediate frame is obtained by two interpolations between first and last frames of two temporal segments of size GAP, and GAPₕ,:

$${I}_{i} = G ( ( \frac{i}{{GAP}_{l}} {w}_{l 2} + ( 1 - \frac{i}{{GAP}_{l}} ) {w}_{l 1} ) + ( \frac{i}{{GAP}_{h}} {w}_{h 2} + ( 1 - \frac{i}{{GAP}_{h}} ) {w}_{h 1} ) ) \qquad Eq ( 12 )$$

Where wₗ₁, wₗ₂, wₕ₁ and wₕ₂ correspond respectively to the encoded frames Iₗ₁, Iₗ₂, Iₕ₁ and Iₕ₂for GAP, and GAPₕ respectively and can be written as follows:

$${w}_{l .} = {T}^{- 1} ( Q ( n T ( E ( {I}_{l .} ) ) ) ) = ( , 0 ) \qquad Eq ( 13 )$$

$${w}_{h .} = {T}^{- 1} ( Q ( 1 - n ) T ( E ( {I}_{h .} ) ) ) ) = 0 ( , . ) \qquad Eq ( 14 )$$

Where n={1,0} ∈N¹⁸, 1 ∈N^{S}, 0 ∈N^{1-S} is a mask to compress only the first s dimensions of the latent codes. It is to be noted that the choice of s and GAP_{I}, GAPₕ can be adapted to the processed videos (e.g., if the main changes are the objects color, the opposite may be adopted).

FIG. 19 illustrates a method for decoding a video according to this embodiment. In this embodiment, as explained above, an intermediate frame Iᵢₙₜₑᵣ is to be generated based on a multiple set of temporal segments of different sizes. For instance, the intermediate frame lᵢₙₜₑᵣ is generated using two GAPs: GAP,, GAPₕ and its corresponding latent code is obtained from two interpolations of latent codes corresponding respectively to the first and last frames of GAP,, GAPₕ temporal segments respectively.

At 1910, the first and last images of a first temporal segment GAP, are decoded, using the method for decoding illustrated on FIG. 11 for example. The decoded latent codes of the first and last images of this first temporal segment would then be used to reconstruct a first set of layers of a latent code of the intermediate frame lᵢₙₜₑᵣ.

At 1920, the first and last images of a second temporal segment GAPₕ are decoded, using the method for decoding illustrated on FIG. 11 for example. The decoded latent codes of the first and last images of this second temporal segment would then be used to reconstruct a second set of layers of the latent code of the intermediate frame lᵢₙₜₑᵣ.

At 1930, the intermediate latent code is obtained by interpolation wherein a first set of layers of the latent code is obtained by interpolation using the corresponding layers of the latent codes of the first and last frames of the first temporal segment and a second set of layers of the latent code is obtained by interpolation using the corresponding layers of the latent codes of the first and last frames of the second temporal segment, as explained above with Equation (12).

At 1940, the intermediate frame lᵢₙₜₑᵣ is generated by the GAN generator.

Temporal adaptive gap (TA-GAP)

Another variant to adapt the GAP is provided wherein the GAP is determined according to the motion or dynamics of each frames segment. To this end, the GAPs are determined for each temporal segment as a preprocessing step, then the video is compressed based on the determined GAP. FIG. 20 illustrates a method for encoding a video according to this embodiment.

At 2010, for a set of images of the video, a size of a temporal segment (GAP) between intra coded images is determined. At 2020, the first and last frames of the determined temporal segment are encoded, using the method illustrated in FIG. 10.

An algorithm for determining sizes of temporal segments is provided below, wherein a result of the algorithm provides a list of the determined temporal segments of the video for encoding.

At initialization, a default size GAP0 is set, a metric M, a metric threshold TM, a threshold tolerance eps and a number of iterations N are initialized to 0.

```
While i< number of frames in the video do
  GAP=GAP0;
  j=0;
  while j<N do
    m=Interpolation(GAP, i, M);
    if m > TM+eps then
      GAP=GAP+1;
    End
    if m < TM-eps then
      GAP = GAP-1;
    else
      ;
      break;
    end
    j=j+1;
  end
  i=i+GAP
end
```

with Interpolation (GAP, i, M) performs linear interpolation of the frames in the temporal segment of size GAP starting from frame i, and return an average metric.

Specifically, in the above algorithm, the average metric (e.g., PSNR) is computed to assess the reconstruction of the intermediate frames given a GAP, if the reconstruction is good that means the motion is relatively steady and the GAP can be increased. If there is high motion, this leads to low reconstruction, thus the GAP is reduced in this case.

The threshold TM depends on the processed video, thus TM is set so that it is less than the best reconstruction/metric that can be obtained by a margin m. It is assumed that the best metric is obtained with the minimal GAP=2.

Once the GAPs have been computed, they are used to compress the video using the method illustrated in FIG. 17, 18.

### Temporal and Layer Specific Adaptive Gap (TLA-GAP)

According to another variant, the variants for determining the GAPs described above (layer-wise, temporal) can be combined, to reduce the compression size. Specifically, instead of using a fixed and small GAP, for the first layers as in LA-GAP, the GAP, is determined as explained in the temporal adaptation TA-GAP.

In another variant, this can also be done for the last layers, but as the GAPₕ used for these layers is already high (e.g., 60), it can be kept constant.

### Experiments

In the following, some results of the embodiments provided above are shown.

### Implementation Details

A StyleGAN2 generator (G) pretrained on FFHQ dataset is used. The images are encoded in W⁺ using a pretrained StyleGAN2 encoder (E), the parameters of the generator and the encoder remain fixed in all the experiments. The latent vector dimension in W⁺ and W*_{c} is 18×512. Celeba-HQ is the image dataset that is used for training and consists of 30000 high quality images (i.e. 1024×1024) of faces.

For the NF model, Real NVP is used without batch normalization. Each coupling layer consists of 3 fully connected (FC) layers for the translation function and 3 FC for the scale one with LeakyReLU as hidden activation and Tanh as output one. A fully factorized entropy model is trained.

Range Asymmetric Numeral System coder is used to obtain the bitstream. The entropy model is based on the implementation in the CompressAl library (Jean Begaint, Fabien Racape, Simon Feltman, and Akshay Pushparaja. Compressai: a pytorch library and evaluation platform for end-to-end compression research). For all the experiments, 2 Adam optimizers with the same parameters are used for both the entropy model and T with 31=0.9 and 32=0.999, learning rate=1 e⁴ and the batch size=8.

Datasets: the method for encoding/decoding a video are evaluated on the MEAD dataset which is a high resolution talking face video corpus for many actors with different emotions and poses. MEAD inter consists of 10 videos of different actors with frontal pose.

The dataset is preprocessed as follows: all the frames are cropped around the face and aligned. As the reconstructed image is compared with the projected one for SGANC, all the frames are projected, encode the original images and reconstruct them using StyleGAN2, except for the method provided herein which takes the original frames as input. All frames are with resolutions (1024×1024).

### Results

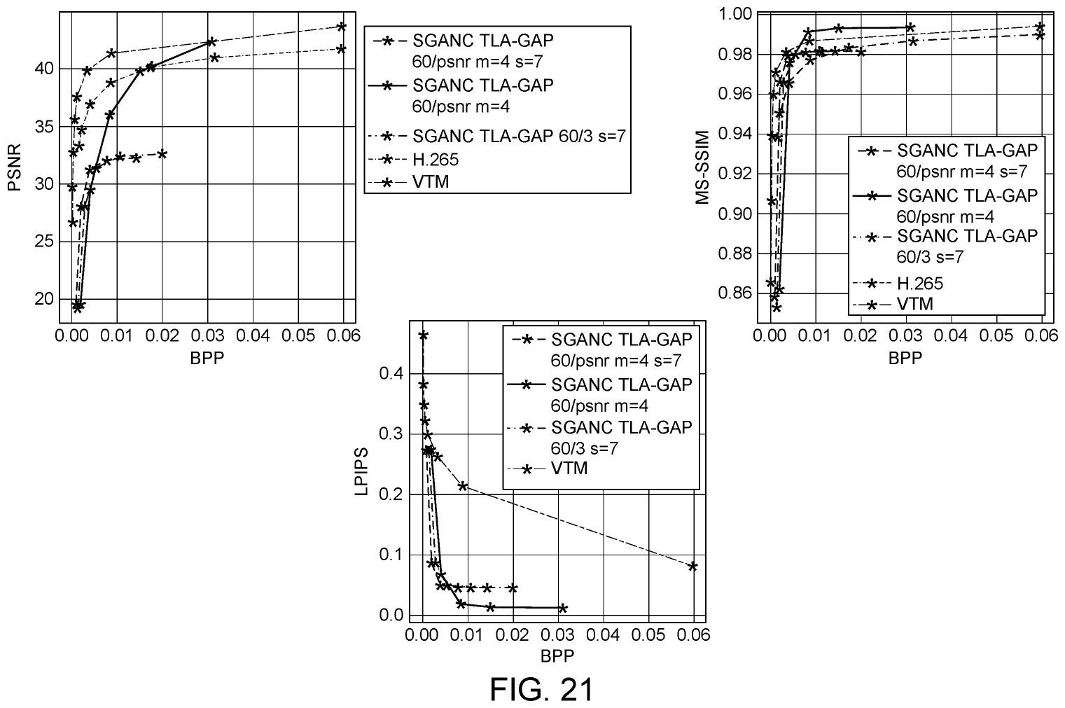

FIG. 21 illustrates some results of the method for encoding/decoding a video, according to some embodiments.

The average of the metrics over all the frames of a given Video are reported. For MEAD inter dataset, the average of the metrics over all the videos is used.

The following metrics are used; Peak Signal to Noise Ratio (PSNR), Multi Scale Structural Similarity (MS-SSIM) and Learned Perceptual Image Patch Similarity (LPIPS). The size of the compressed images in bits per pixel (BPP) is reported.

It is to be noted that all the distortion metrics of the provided method (SGANC) are reported with respect to the projected image while all the others are with respect to the original one.

The following methods are compared:
SGANC TLA-GAP (s=7, GAPₕ=60, m=4, metric=PSNR),
SGANC TA-GAP (m=4, metric=PSNR),
SGANC LA-GAP (s=7, GAP_{R}=3, GAPₕ=60)
Versatile Video Coding Test Model (VTM) of VVC, with Random access with GOP (group of frames)=16
H.265 video standard.

Quantitative results: From FIG. 21, it can be noticed that for pixel wise metrics such as PSNR, VTM and H.265 are better than the methods provided herein; but for perceptual metrics such as MS-SSIM, the methods provided herein performs better than H.265 and competitive with VTM.

For the LPIPS loss, the methods provided herein performs better than VTM. Note that, for SGANC, the distortion is measured from the quantization (Projected vs SGANC).

### Ablation Study:

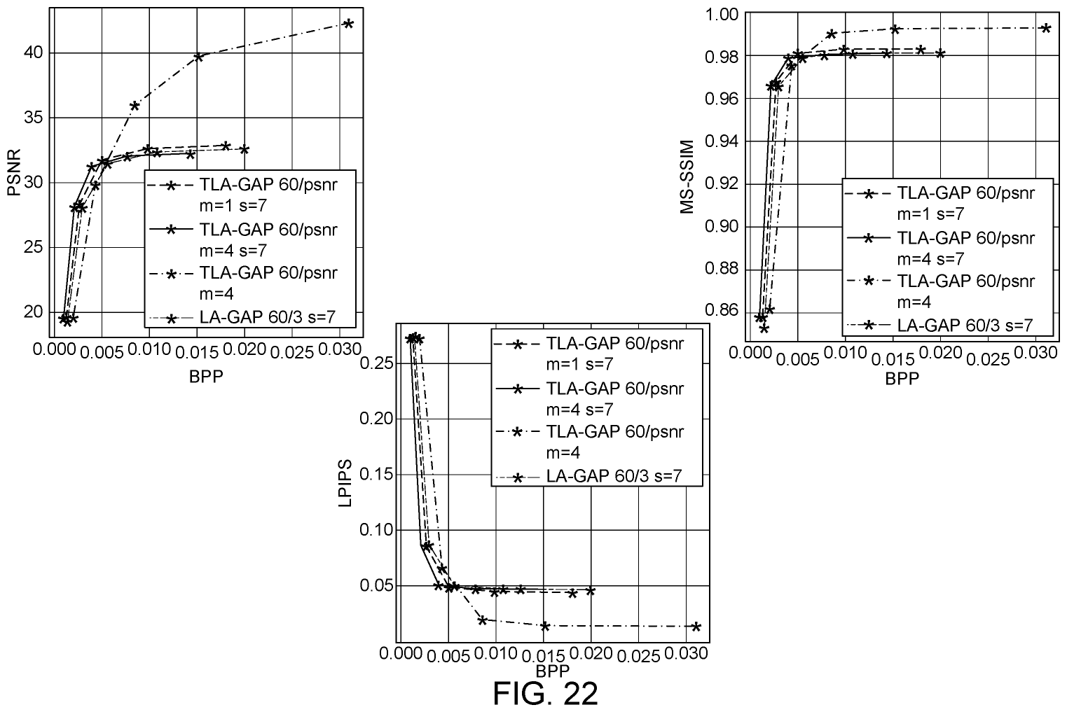

FIG. 22 illustrates further results of the method for encoding/decoding a video, according to some variants for determining the GAP.

Implementation details: the following variants are compared:
SGANC TA-GAP (m=4, metric=PSNR),
SGANC LA-GAP (s=7, GAP_{R}=3, GAPₕ=60)
SGANC TLA-GAP (s=7, GAPₕ=60, m=4, metric=PSNR).
The same model is used for these 3 variants (same setup as above).

From FIG. 22, it can be noticed that the reconstruction of TA-GAP is significantly higher than LA-GAP or TLA-GAP. As quantitatively, TLA-GAP has good reconstruction, this variant is favorized to gain reduction in BPP. The effect of the margin m is not significant, thus a relatively higher margin is desirable. Note that, if the margin is increased, the motion in video becomes slow.

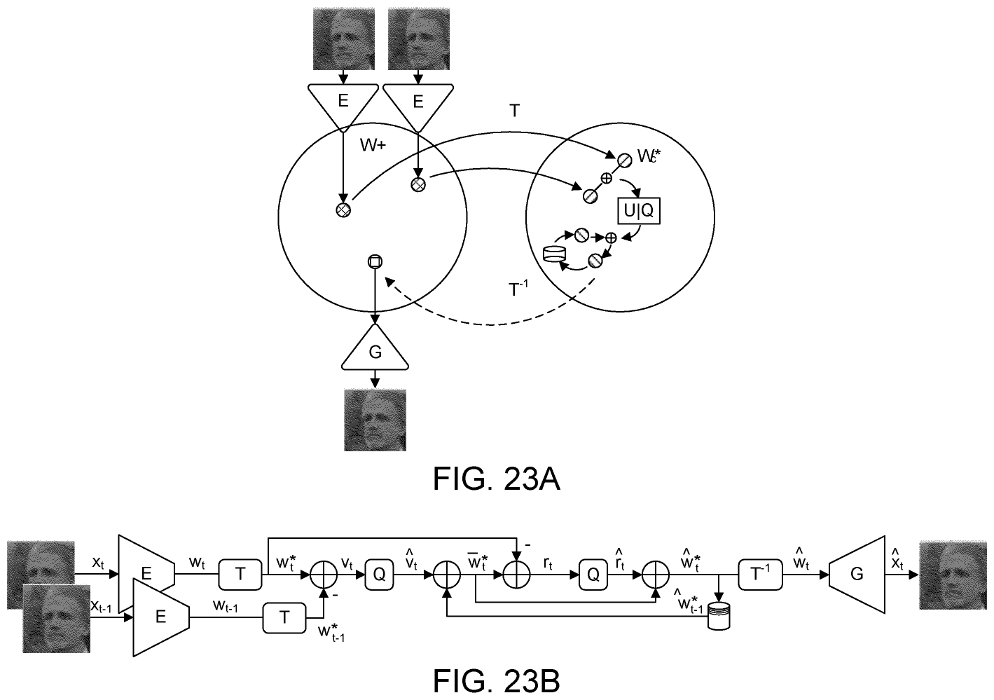

FIG. 23A and FIG. 23B illustrate an example of a method for encoding and decoding a video according to another embodiment. According to this embodiment, inter coding is performed based on residual determined in the proxy latent space.

As illustrated in FIGS. 23A and B, a sequence of frames {x₁, x₂, . . . , xₜ₋₁, xₜ, . . . }, is encoded using the pretrained (and fixed) encoder E. In other words, the frames are projected using the pretrained encoder E to the style GAN latent space W⁺: {w₁,w₂, . . . , wₜ₋₁, wₜ, . . . }, and mapped to the proxy latent space W*_{c} using the learned transformation T to obtain a sequence of latent codes {w*₁, w*₂, . . . , w*ₜ₋₁, w*ₜ.}. Inter-coding is then performed in the proxy latent space W*_{c} using a learned entropy model U/Q. [symbol] A first latent code of the sequence is intra coded: [symbol] using the same entropy model as the one described for image compression or another entropy model trained for image compression. The first latent code can be the latent code of the first image of the video sequence or a first image of a group of frames when the video sequence is fragmented into groups of frames.

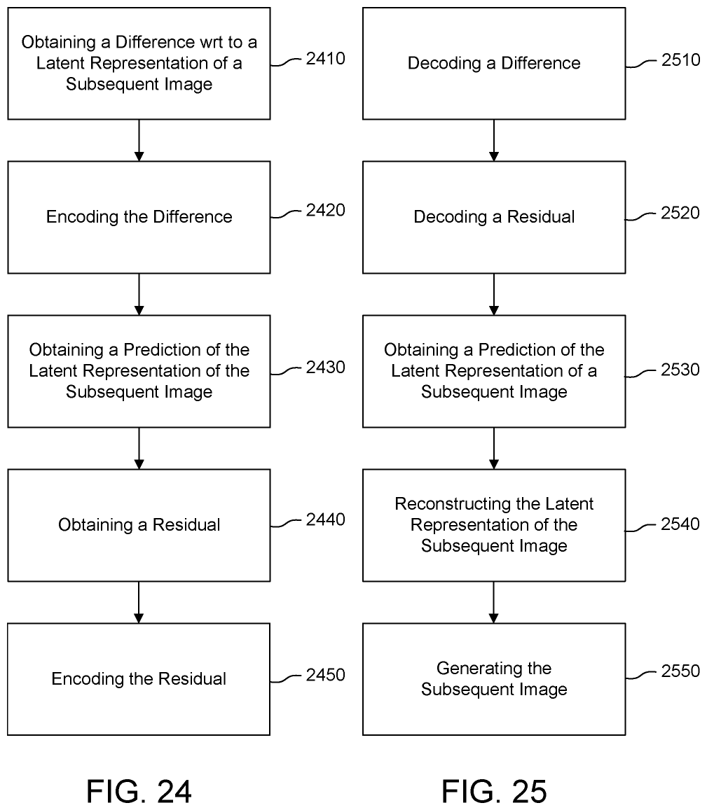

The following steps are repeated until the end of the video sequence or group of frames: FIG. 24 illustrates a method for encoding a video according to this embodiment. At 2410, a difference between two consecutive latent codes is obtained, namely the current latent code to compress and a previous latent code. At 2420, the difference is then quantized and entropy coded for instance in a bitstream, to obtain [symbol] =Q(w*ₜ−w*ₜ₋₁).

At 2430, a prediction (estimate) wₜ of the current latent code wₜ* is determined from the previously reconstructed code [symbol] and the reconstructed difference with: wₜ*= [symbol] + [symbol] .

At 2440, the residual between the prediction and the current latent code is computed and at 2450, the residual is quantized and entropy coded (for all the frames or each GAP frames): [symbol] =Q(wₜ−wₜ^{*}).

The quantized difference [symbol] and the residual [symbol] are compressed using entropy coding and sent to a receiver. The current latent code is reconstructed [symbol] from the prediction and the reconstructed residual and stored for compressing the subsequent latent codes.

FIG. 25 illustrates a method for decoding a video according to this embodiment, and more particularly for reconstructing a current image that has been inter-coded. At 2510, the difference between the current latent code and a latent code of a previous image is decoded from coded video data. According to a variant, at 2520, the prediction residual is also decoded from the coded video data. At 2530, the prediction of the current latent code is obtained from the reconstructed latent code of a previously decoded image [symbol] and the reconstructed difference [symbol] . At 2540, the current latent code is reconstructed from the decoded residual and the prediction of the latent code, or depending on the variant only from the prediction latent code: [symbol] =wₜ^{*}+ [symbol] . At 2550, the reconstructed latent code in the latent space W*_{c} is remapped to W⁺ to generate the decoded image using the pretrained generator G, for instance the StyleGAN2.

According to the video encoding and video decoding methods described above, the transformation T from mapping the latent codes from W⁺ to the proxy latent space W*_{c} and the entropy model (p) are learned (trained) to optimize a rate-distortion loss which can be written as follows:

$${L}_{i n t e r} = d ( {w}_{t} , {T}^{- 1} ( ) ) - λ E [ {\sum }_{i}^{D} {log}_{2} {p}_{i} ( ) ] \qquad Eq ( 15 )$$

where d is any distortion measure between the latent code from W⁺ and the reconstructed latent code in W⁺ after mapping T, encoding and inverse mapping T⁻¹, λ is a trade-off parameter, and E[Σᵢ^{D} log₂ pᵢ( [symbol] )] is an estimate of the coding cost, where E is the expectation, pᵢ is the dimension i of the entropy model (entropy model P with dimension being the dimension of the latent code). One entropy model is trained for the differences. In operation, the learned entropy model is also used for both the differences and the residuals.

The quantization/compression are replaced by adding noise in a similar manner as in the embodiment using interpolation to obtain intermediate frames. It is to be noted that using one entropy model for both the latent code differences and residuals (during test) leads to better results. Thus, according to a variant, a same entropy model is trained for the differences and residuals. Having only few dimensions that change between two consecutive latent codes is efficient for entropy coding, thus according to a variant, an L1 regularization is added on the latent codes differences and the final loss becomes:

$$Loss = {L}_{i n t e r} + {λ}_{L 1} \vert {w}_{t - 1}^{*} - {w}_{t}^{*} \vert \qquad Eq ( 16 )$$

It has been shown that each stage/layer of the StyleGAN generator corresponds to a specific scale of details. Specifically, the first layers, which correspond to coarse resolution (e.g. 4²-8²) affect mainly high level aspects of the image such as the pose and face shape, while the last layers affect the low level aspects such as textures, colors and small micro structures. According to a variant, such a hierarchical structure is used and different distortion are used for each layer of the generator.

For instance, the latent codes in W⁺ or W*_{c} consist of 18 latent codes of dimension 512 and each one corresponds to one layer in the generator, hence its dimension is (18, 512).

Specifically, in this variant, smaller A are used for the last layers and larger ones for the first ones.

It is to be noted that when using different distortions, it is better to use also different entropy models and normalizing flows. As a trade-off between complexity and compression efficiency, a stage-specific entropy models/NF is used (i.e. 3 stages are used:1-8, 8-13, 13-18) while using different A for each layer.

Below, algorithms for video compression using inter coding with residual as described above are provided.

Algorithm for the video encoding/decoding method with residual inter-coding (SGANC IC): The result of the method is coded video data comprising a sequence of N compressed frames or a bitstream comprising code data representative of the compressed frames sequence: { [symbol] , [symbol] , [symbol] , . . . , [symbol] , [symbol] , . . . , [symbol] }, with N being the number of frames. In the following, E stands for the GAN encoder, G the GAN generator, T the learned transformation, EC the entropy coder, ED the entropy decoder and Q the quantizer, and GAP being a number of frames in a group of fames.

According to an embodiment, residual coding is performed by groups of frames. In other words, the residual is determined and coded only for the first frame of the group of frames.

At initialization, the frame sequence {x₀, x₁, x₂, . . . , xₜ₋₁, xₜ, . . . , X_{N}} is input to the method, and the first frame is intra coded with [symbol] =ED (EC(Q(T(E(xo)))));

```
t= 1;
while t < N do
  w*ₜ = T(E(xₜ));
  w*ₜ₋₁ = T(E(xₜ₋₁)); this encodes the current and previous frames in the GAN latent space and
  maps the latent codes from the GAN latent space to the proxy latent space [symbol]
  = ED(EC(Q(w*ₜ − w*ₜ₋₁); this quantizes, compresses and decompresses the difference [symbol]
  = [symbol]     + [symbol]    ; this determines an estimate (prediction) of the latent code of the current frame
  if t%GAP == 0 then [symbol]
    = ED(EC(Q(w*ₜ − [symbol]    )))_{;} this quantizes, compresses and decompresses the residual [symbol]
    = [symbol]     + [symbol]    ; this reconstructs the latenet code of the current frame
  else [symbol]
    = [symbol]    ;
  end [symbol]
  = G(T⁻¹( [symbol]   )); this reconstructs the current frame
  t=t+1;
end
```

Below is provided the corresponding algorithm 3 of the method used for training, The results of the algorithm are thus the learned transformation T and the entropy model EM.

As input to the training, a video dataset encoded as latent codes in the GAN latent space are provided, with {w₁, w₂, . . . , wₜ₋₁, wₜ, . . . } being the latent codes of a video sequence, N being a number of frames in each video sequence, S being the size of the dataset, E the GAN encoder and G the GAN generator.

```
While i < S do
  t=1; L=0;
  while t<N do
    w*ₜ, w*ₜ₋₁ = T(wₜ), T(wₜ₋₁); maps the latent codes to the proxy latent space W*_{c} [symbol]
    = Q(w*ₜ − w*ₜ₋₁); quantizes (adding noise) the difference: this step comprises
quantization, and entropy coding and decoding using the trained entropy model EM [symbol]
    = [symbol]     + [symbol]    ; determines an estimate (prediction) of the latent code [symbol]
    = [symbol]    _{;}
    L= L + Loss; computes the loss (Eq(15 or 16)).
    t = t + 1;
  end
  update the parameters of T and EM to minimize L;
  i = i+1;
end
```

### IMPLEMENTATION DETAILS for the SGANC-IC Embodiment

A StyleGAN2 generator (G) pretrained on FFHQ dataset is used. The images are encoded in W⁺ using a pretrained StyleGAN2 encoder (E). The parameters of the generator and the encoder remain fixed in all the experiments. The latent vector dimension in W⁺ and W*_{c} is 18×512. Celeba-HQ is the image dataset that is used for training and consists of 30000 high quality images (i.e. 1024×1024) of faces. To accelerate the training, all the images are encoded once and the training is done using the latent codes.

For the NF model, Real NVP is used without batch normalization. Each coupling layer consists of 3 fully connected (FC) layers for the translation function and 3 FC for the scale one with LeakyReLU as hidden activation and Tanh as output one.

For the SGANC IC, the models were trained on 2.5 k videos from the MEAD dataset, where each batch contains video slices of size of 9 frames. All the frames are pre-processed as in the embodiment of the SGANC with interpolation. A fully factorized entropy model is trained.

Range Asymmetric Numeral System coder is used to obtain the bitstream. The entropy model is based on the implementation in the CompressAl library. For all the experiments, 2 Adam optimizers with the same parameters are used for both the entropy model and T with β1=0.9 and β2=0.999, learning rate=1e⁴ and the batch size=8.

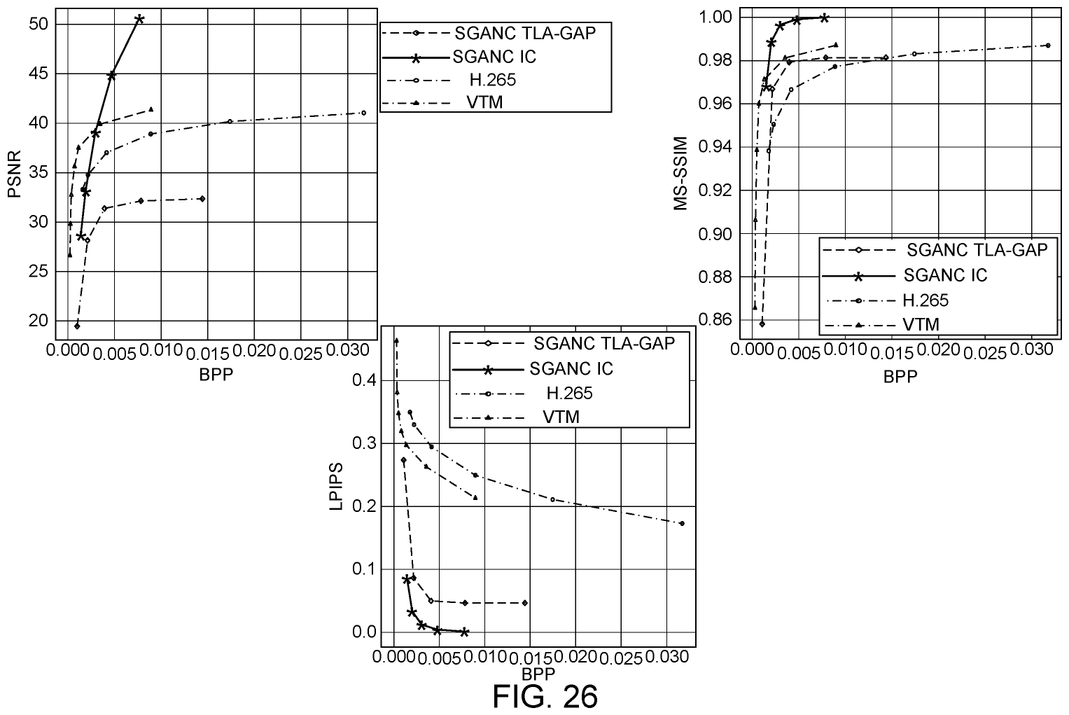

FIG. 26 illustrates rate-distortion curves on the MEAD inter dataset. The SGANC IC shows better perceptual distortion. From FIG. 26, it can be noticed that the SGANC IC method is better than VTM and H.265 in terms of perceptual metrics such as LPIPS. In terms of MS-SSIM, the SGANC IC method is better than H.265 and VTM. In terms of PSNR, SGANC IC becomes better than VTM for high quality regimes. Note than, SGANC IC quantitatively outperforms significantly SGANC TLA-GAP as in the latter small details and micro structures were discarded in the frames.

In the following, the ablation study for SGANC IC investigates the effect of the following:
the GAP for doing residual coding (referred with a g), L1 regularization of Eq(16), residual coding (referred with res) vs intra coding (intra) each GAP, stage specific entropy model; using different entropy models and distortion lambda for the different stages of StyleGAN2 (SS) and using 2 entropy models for the residual and the latent codes differences (2 EM). The following variants are thus compared:
   SGANC IC intra g10: replacing the residual coding at each GAP=10 by intra coding using one of the image processing models that has be trained above in the image compression section.
   SGANC IC res g10: doing residual coding each GAP=10• SGANC IC res g80: doing residual coding each GAP=80.
   SGANC IC res g10 L1: Adding the L1 regularization Eq (16) during training and doing residual coding each GAP=10.
SGANC res g10 SS: Using 3 entropy models and 3 NF models for each stage of the StyleGAN2 (1-7, 7-13, 13-18). In addition, training with layer specific distortion lambda: A=oA where ow=1 for the first stage and decrease from 1 to 0,01 for the second and third stages.
SGANC res g10 SS L1: residual coding each GAP=10, stage specific entropy models and L1 regularization.
SGANC res g2 SS L1 (ours): same as before but with GAP=2.
SGANC res g0 SS L1: Same as before but doing a residual coding each frame (GAP=0).
SGANC res g0 SS L1 2 EM: same as before but training 2 entropy models: one for residual and one for latent codes difference.

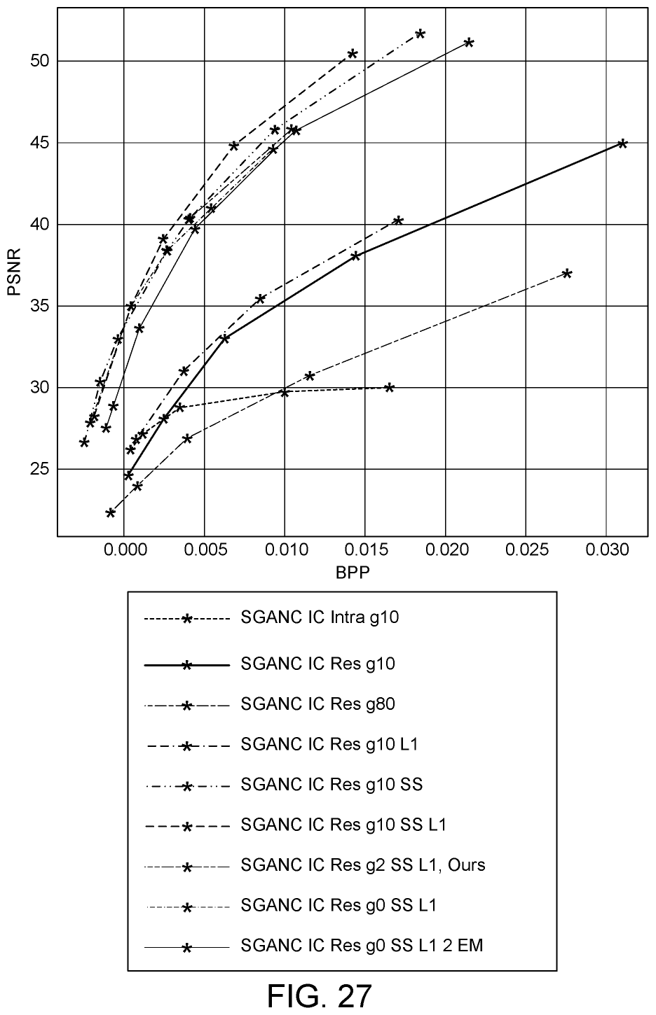

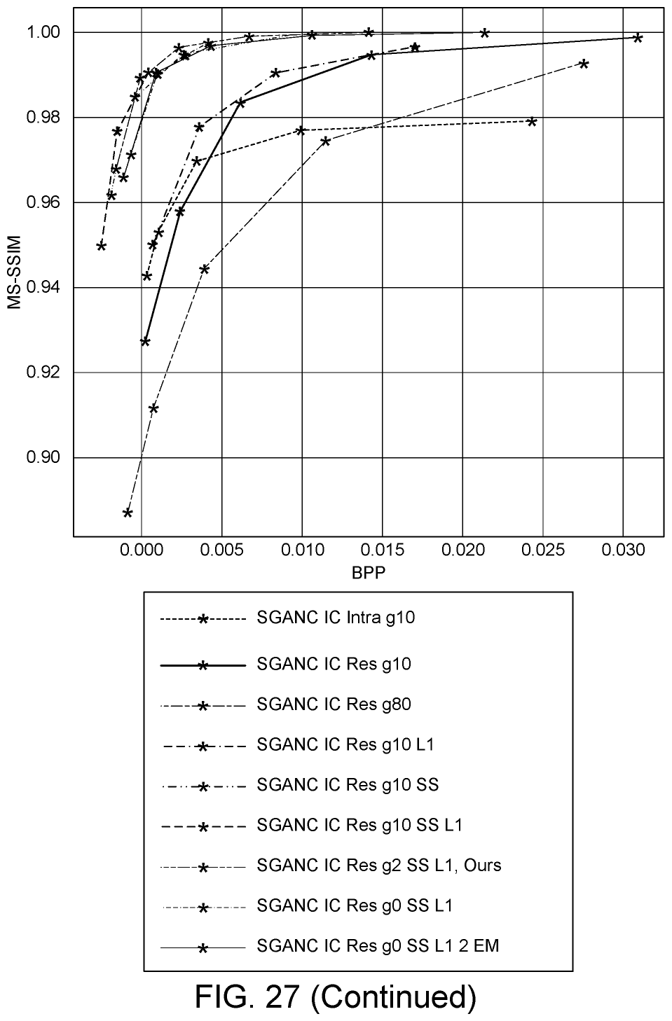

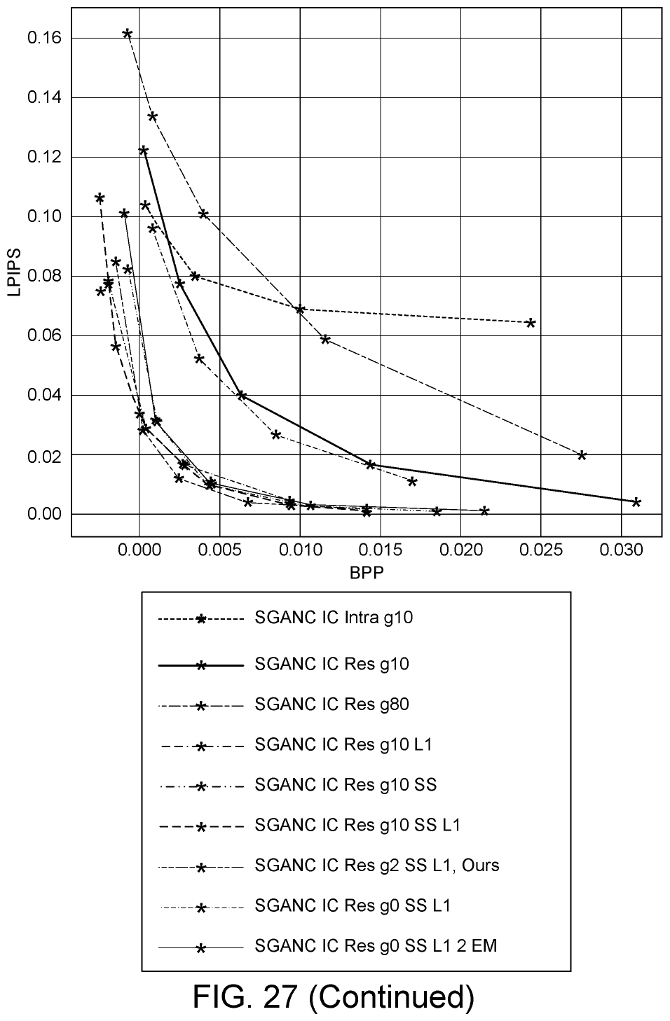

FIG. 27 illustrates results from the ablation study for video compression using inter coding on MEAD inter dataset of the different embodiments. From FIG. 27, it can be noticed that:
Decreasing the GAP is better, though, using a GAP=0 increases the BPP for low bitrates regimes.
a significant improvement is shown by doing residual coding (SGANC IC intra g10 vs SGANC IC res g10) and using stage specific entropy models (SGANC IC res g10 vs SGANC IC res g10 SS).
a slight improvement is shown by adding the L1 regularization during training (SGANC res g10 vs SGANC res g10 L1), though, the improvement becomes negligeable when using SS entropy models (SGANC res g10 SS vs SGANC res g10 SS L1).
Using separate entropy models for the residual and the latent codes differences does not seem to improve (SGANC res g0 SS L1 vs SGANC res g0 SS L1 2 EM).

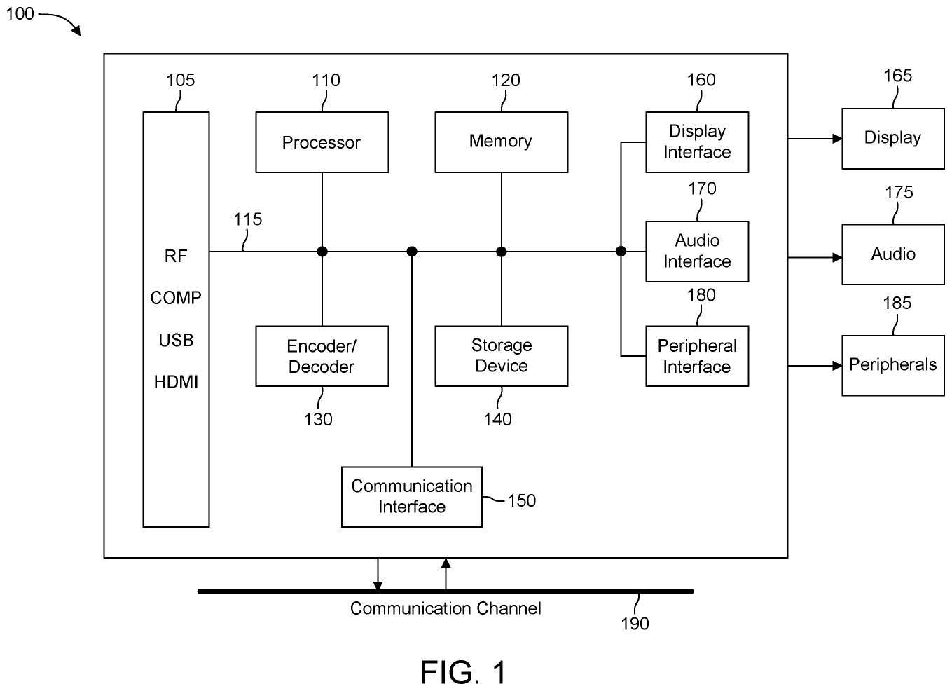

FIG. 1 illustrates a block diagram of a system within which aspects of the present embodiments may be implemented, according to an embodiment.

According to an embodiment, the methods described above are implemented as instructions causing one or more processors to perform the methods steps.

According to an embodiment, FIG. 1 illustrates a block diagram of an example of a system in which various aspects and embodiments described above can be implemented. System 100 may be embodied as a device including the various components described below and is configured to perform one or more of the aspects described in this application. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

According to an embodiment, system 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, one of more input video shots, mosaic images, warpings, 3D models, color transform information, visibility maps, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during pre-processing steps of the method described herein and/or video editing. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the 12C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

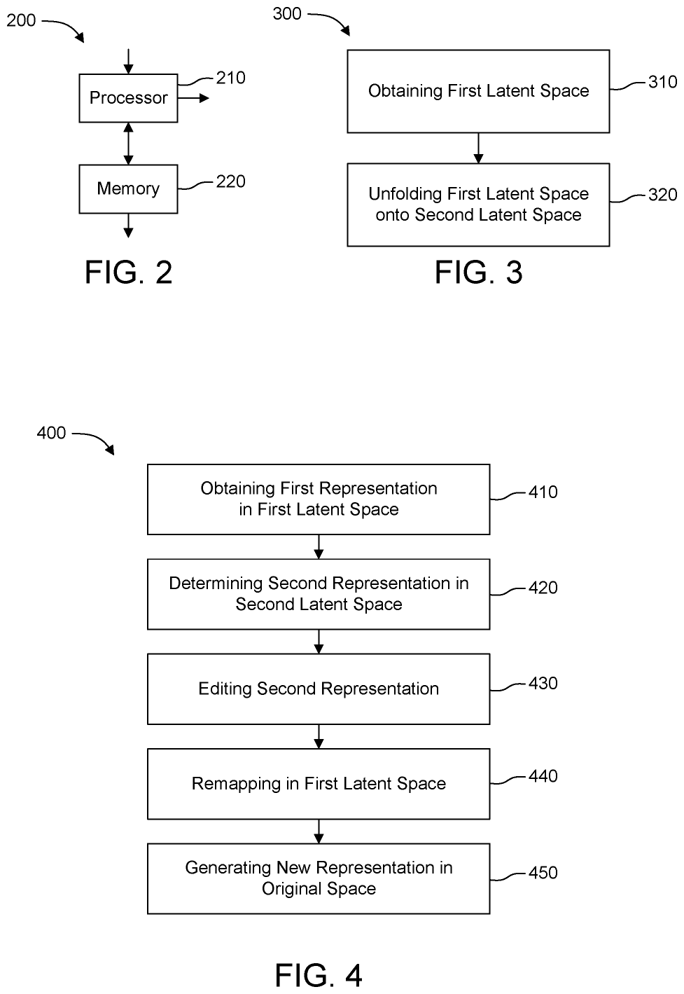

FIG. 2 illustrates a block diagram of a system within which aspects of the present embodiments may be implemented, according to another embodiment. FIG. 2 shows one embodiment of an apparatus 200 for unfolding a first latent space onto a second latent based on a constraint using the aforementioned methods. The apparatus comprises Processor 210 and can be interconnected to a memory 220 through at least one port. Both Processor 210 and memory 220 can also have one or more additional interconnections to external connections.

Processor 210 is also configured to either receive an image or output a generated image and, either implementing a GAN encoder, or a GAN generator, or the learnt transformation T or T⁻¹ to unfold the first latent space onto the second latent space/encode at least one image or decode at least one image, using the aforementioned methods.

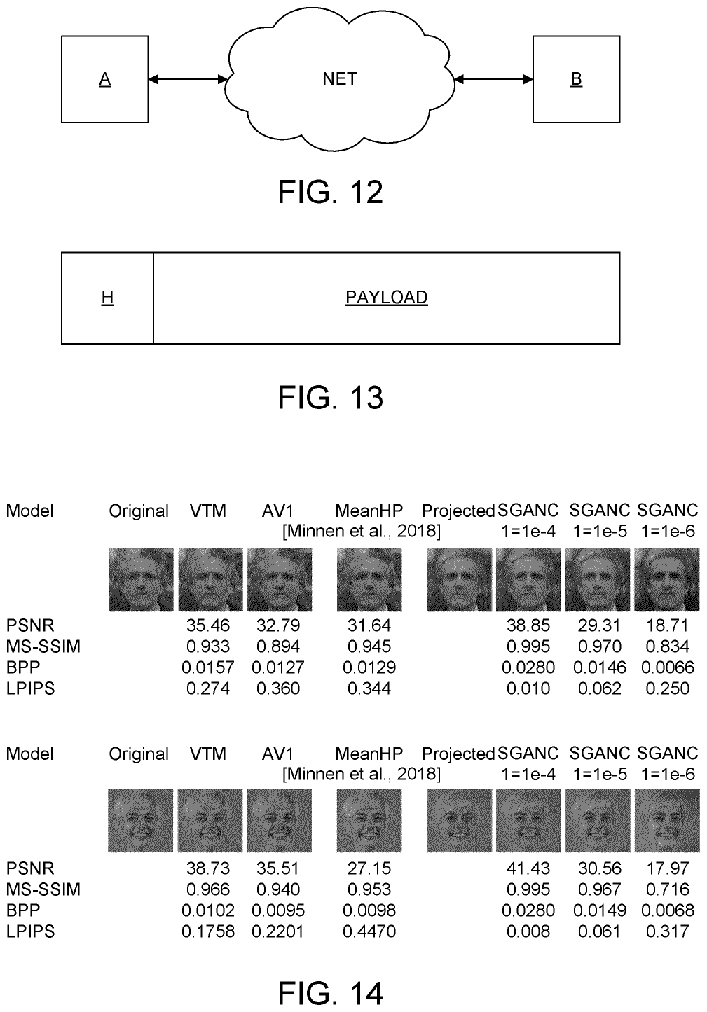

According to an example of the present principles, illustrated in FIG. 12, in a transmission context between two remote devices A and B over a communication network NET, the device A comprises a processor in relation with memory RAM and ROM which are configured to implement any one of the embodiments of the method for encoding at least one image as described in relation with the FIGS. 1-11 and the device B comprises a processor in relation with memory RAM and ROM which are configured to implement any one of the embodiments of the method for decoding at least one image as described in relation with FIGS. 1-11.

In accordance with an example, the network is a broadcast network, adapted to broadcast/transmit encoded images from device A to decoding devices including the device B.

A signal, intended to be transmitted by the device A, carries at least one bitstream comprising coded data representative of at least one image.

FIG. 13 shows an example of the syntax of such a signal when the at least one coded image is transmitted over a packet-based transmission protocol. Each transmitted packet P comprises a header H and a payload PAYLOAD.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Unless indicated otherwise, or technically precluded, the aspects described in this application can be used individually or in combination.

Various numeric values are used in the present application. The specific values are for example purposes and the aspects described are not limited to these specific values.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device.

Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for encoding at least one image, including:
obtaining a first latent representation of the image using an inversion of a generative adversarial network,
obtaining a second latent representation of the at least one image from the first latent representation of the image, using an invertible transformation, and encoding the second latent representation.

2. An apparatus for encoding at least one image, comprising one or more processors operable to:
obtain a first latent representation of the image; using an inversion of a generative adversarial network,
obtain a second latent representation of the at least one image from the first latent representation of the image, using an invertible transformation, and
encode the second latent representation.

3. The method of claim 1, wherein a latent space of the second latent representation is obtained from an unfolding of a latent space of the generative adversarial network based on a rate-distortion constraint.

4. (canceled)

5. The method of claim 1, wherein the at least one image is part of a sequence of images, and wherein encoding the at least one image further includes:
obtaining a difference between a second latent representation of a subsequent image from the sequence of images and the second latent representation of the at least one image, and
encoding the difference.

6. The method of claim 5, wherein encoding the at least one image further includes:
decoding the encoded second latent representation of the at least one image
decoding the encoded difference,
obtaining a prediction of the second latent representation of the subsequent image from the decoded second latent representation of the at least one image and the decoded difference,
obtaining a residual between the second latent representation of the subsequent image and the prediction, and
encoding the residual.

7. The method of claim 1, wherein encoding comprises at least one of quantization or entropy coding.

8-10. (canceled)

11. The method of claim 1, wherein the invertible transformation is a normalizing flow.

12. A method comprising decoding at least one first image from image or video data, including:
decoding from the image or video data a first latent representation of the at least one first image,
obtaining a second latent representation of the at least one first image from the decoded first latent representation using an invertible transformation, and
generating the at least one first decoded image from the second latent representation using a generative adversarial network.

13. An apparatus for decoding at least one first image from image or video data, comprising one or more processors operable to,
decode from the image or video data a first latent representation of the at least one first image,
obtain a second latent representation of the at least one first image from the decoded first latent representation using an invertible transformation, and
generate the at least one first decoded image from the second latent representation using a generative adversarial network.

14. The method of claim 12, wherein the at least one first image is part of a sequence of images, the method further comprises:
decoding from the image or video data a first latent representation of a second image of the sequence of images,
obtaining a second latent representation of the second image from the decoded first latent representation of the second image using the invertible transformation,
obtaining at least one second latent representation of a third image of the sequence of images from at least the second latent representation of the at least one first decoded image and the second latent representation of the second image, and generating the third decoded image from the second latent representation of the third image using a generative adversarial network.

15. The method of claim 14, wherein obtaining the at least one second latent representation of the third image comprises interpolating the second latent representation of the at least one first image and the second latent representation of the second image.

16. The method of claim 15, wherein the interpolation is linear.

17. The method of claim 15, wherein the interpolation uses at least one scale factor, wherein the at least one scale factor depends on at least one layer of the second latent representation of the at least one first image and of the second latent representation of the second image that are used in the interpolation for generating the corresponding layers of the second latent representation of the third image or the at least one scale factor represents a temporal distance between the at least one first image and the second image.

18-19. (canceled)

20. The method of claim 12, wherein the at least one first image is part of a sequence of images, and wherein decoding at least one first image further includes:
decoding from the image or video data a difference latent code for a subsequent image of the sequence of images,
obtaining the second latent representation of the subsequent image from the decoded difference and the decoded second latent representation of the at least one first image in the second latent, and
generating the subsequent decoded image from the second latent representation of the subsequent image using a generative adversarial network.

21. The method of claim 20, wherein obtaining the second latent representation of the subsequent image further comprises:
decoding from the image or video data a residual, and
adding the residual to the second latent representation of the subsequent image.

22. The method of claim 12, wherein decoding the first latent representation of the at least one first image or decoding the difference or decoding the residual comprises at least one of dequantization or entropy decoding.

23. The method of claim 22, wherein entropy decoding uses a same trained entropy model for decoding the difference latent code and the residual.

24. (canceled)

25. The method of claim 12, wherein obtaining the second latent representation of the at least one first image from the decoded first latent representation comprises mapping the decoded first latent representation from a proxy latent space designed for compression to a latent space of the generative adversarial network using the invertible transformation.

26-27. (canceled)

28. The method of claim 12, wherein the invertible transformation is a normalizing flow.

29-35. (canceled)

36. A non-transitory computer readable medium comprising A-a bitstream comprising image or video data representative of a latent representation of at least one first image obtained according to claim 1.

37. (canceled)

38. A computer readable storage medium having stored thereon instructions for causing one or more processors to perform the method of claim 12.

39. The apparatus of claim 12, further comprising:
at least one of (i) an antenna configured to receive a signal, the signal including data representative of at least one image, (ii) a band limiter configured to limit the received signal to a band of frequencies that includes the data representative of the at least one image, or (iii) a display configured to display at least one part of the at least one image.

40. The apparatus according to claim 39, comprising a television (TV), a cell phone, a tablet or a set top box.

41-42. (canceled)

43. The apparatus of claim 13, wherein the invertible transformation is a normalizing flow.

44. The apparatus of claim 13, wherein the at least one first image is part of a sequence of images, and wherein the one or more processors are further configured to:
decode from the image or video data a difference latent code for a subsequent image of the sequence of images,
obtain the second latent representation of the subsequent image from the decoded difference and the decoded second latent representation of the at least one first image, and
generate the subsequent decoded image from the second latent representation of the subsequent image using a generative adversarial network.
